(19) United States
(12) Patent Application Publication
(10) Pub. No.: US 2026/0194344 A1
(43) Pub. Date: Jul. 9, 2026

(54) SYSTEMS AND METHODS FOR SEQUENTIAL AND PARALLEL OPTICAL DETECTION OF ALIGNMENT MARKS

(71) Applicant: ASML NETHERLANDS B.V., Veldhoven (NL)

(72) Inventors: Arjan Johannes Anton BEUKMAN, Son en Breugel (NL); Franciscus Godefridus Casper BIJNEN, Valkenswaard (NL)

(73) Assignee: ASML NETHERLANDS B.V., Veldhoven (NL)

(21) Appl. No.: 19/131,091

(22) PCT Filed: Nov. 9, 2023
(86) PCT No.: PCT/EP2023/081365

§ 371 Date: May 19, 2025

Related U.S. Application Data
(60) Provisional application No. 63/431,285, filed on Dec. 8, 2022.

(51) Int. Cl. G01B 11/27

(52) U.S. Cl. CPC G01B 11/272

(57) ABSTRACT

A sensor apparatus includes a sensor array and a metrology stage coupled to the sensor array. The sensor array includes a plurality of sensors. Each sensor of the sensor array is configured to illuminate radiation to a diffraction target on a substrate and detect a signal beam including diffraction order sub-beams diffracted from the diffraction target. The metrology stage is configured to move the sensor array relative to the substrate. The sensor apparatus is configured to measure a plurality of diffraction targets on the substrate at a rate based on a density of the plurality of sensors relative to the plurality of diffraction targets.

### CROSS-REFERENCE TO RELATED APPLICATION

This application claims priority of U.S. application 63/431,285 which was filed on 8 Dec. 2022, and which is incorporated herein in its entirety by reference.

### TECHNICAL FIELD

The present disclosure relates to sensor apparatuses, systems, and methods, for example, sensor apparatuses, systems, and methods for lithographic apparatuses and systems.

### BACKGROUND

A lithographic apparatus is a machine constructed to apply a desired pattern onto a substrate. A lithographic apparatus can be used, for example, in the manufacture of integrated circuits (ICs). A lithographic apparatus may, for example, project a pattern of a patterning device (e.g., a mask, a reticle) onto a layer of radiation-sensitive material (resist) provided on a substrate.

To project a pattern on a substrate a lithographic apparatus may use electromagnetic radiation. The wavelength of this radiation determines the minimum size of features that can be formed on the substrate. A lithographic apparatus, which uses extreme ultraviolet (EUV) radiation, having a wavelength within the range 4-20 nm, for example 6.7 nm or 13.5 nm, may be used to form smaller features on a substrate than a lithographic apparatus, which uses, for example, deep ultraviolet (DUV) radiation with a wavelength of 157 nm or 193 nm or 248 nm.

In order to control a lithographic process to form device features accurately on a substrate, one or more targets are provided on the substrate. A lithographic apparatus uses one or more sensors that accurately measures a characteristic of the target. Existing alignment systems and techniques are subject to certain drawbacks and limitations. For example, prior systems utilize a single sensor head and are in general relatively slow and bulky. Further, prior sensors take significant time to move from one target to the next and, thus, during operation the sensors spend most of the time idling. In addition, there are limitations in the speed sensors can translate from one target to the next, and limitations in the required dwell time per measurement.

Compact systems can increase accuracy, yield, cost efficiency, and scalability and decrease errors in a lithographic process since hundreds of sensors can be implemented in a sensor array on the same common platform. Integration of components can provide a miniaturized sensor array for measuring particular characteristics of one or more targets on the substrate, sequentially or in parallel. Multiple targets of the same substrate can be investigated simultaneously with the sensor array. Additionally, integrated optics can provide customized patterns for corresponding target geometries, allowing for simultaneous measurement of all relevant targets on the substrate, thus increasing speed and accuracy.

### SUMMARY

Accordingly, there is a need to, e.g., provide a reduced footprint and compact sensor array that is scalable, increase accuracy and speed of measuring targets on a substrate, increase the number of targets that can be measured in a given time (e.g., at least 300 marks), increase a density of the sensors relative to the targets, decrease idling time, decrease errors in a lithographic process, and increase fabrication throughput and yield of a lithographic process.

In some aspects, an apparatus includes a sensor array and a metrology stage coupled to the sensor array. In some aspects, the sensor array can include a plurality of sensors. In some aspects, each sensor of the sensor array can be configured to illuminate radiation to a diffraction target on a substrate including a plurality of diffraction targets. In some aspects, each sensor of the sensor array can be further configured to detect a signal beam including diffraction order sub-beams reflected from the diffraction target. In some aspects, the metrology stage can be configured to move the sensor array relative to the substrate. In some aspects, the apparatus can be configured to measure the plurality of diffraction targets at a rate based on a density of the plurality of sensors relative to the plurality of diffraction targets.

In some aspects, the apparatus can be configured to measure the plurality of diffraction targets at a rate of at least 10 diffraction targets per second. In some aspects, the apparatus can be configured to measure the plurality of diffraction targets at a rate of at least 20 diffraction targets per second. In some aspects, the apparatus can be configured to measure the plurality of diffraction targets at a rate of at least 30 diffraction targets per second. In some aspects, the apparatus can be configured to measure the plurality of diffraction targets at a rate of at least 50 diffraction targets per second. In some aspects, the apparatus can be configured to measure the plurality of diffraction targets at a rate of at least 55 diffraction targets per second. In some aspects, the apparatus can be configured to measure the plurality of diffraction targets at a rate of at least 60 diffraction targets per second.

In some aspects, the apparatus can be configured to measure the plurality of diffraction targets at a rate of at least 100 ms per diffraction target. In some aspects, the apparatus can be configured to measure the plurality of diffraction targets at a rate of at least 50 ms per diffraction target. In some aspects, the apparatus can be configured to measure the plurality of diffraction targets at a rate of at least 30 ms per diffraction target. In some aspects, the apparatus can be configured to measure the plurality of diffraction targets at a rate of at least 20 ms per diffraction target. In some aspects, the apparatus can be configured to measure the plurality of diffraction targets at a rate of at least 18 ms per diffraction target. In some aspects, the apparatus can be configured to measure the plurality of diffraction targets at a rate of at least 15 ms per diffraction target.

In some aspects, the apparatus can be configured to decrease an overlay error based on detection of higher spatial frequency deformations of the substrate.

In some aspects, the density of the plurality of sensors can be at least equal to a density of the plurality of diffraction targets. In some aspects, the density of the plurality of sensors can be at least five times that of a density of the plurality of diffraction targets. In some aspects, the density of the plurality of sensors can be at least ten times that of a density of the plurality of diffraction targets. In some aspects, the density of the plurality of sensors can be at least twenty times that of a density of the plurality of diffraction targets. In some aspects, the density of the plurality of sensors can be at least fifty times that of a density of the plurality of diffraction targets. In some aspects, the density of the plurality of sensors can be at least a hundred times that of a density of the plurality of diffraction targets.

In some aspects, a density of the plurality of diffraction targets can be at least two times that of the density of the plurality of sensors. In some aspects, a density of the plurality of diffraction targets can be at least five times that of the density of the plurality of sensors. In some aspects, a density of the plurality of diffraction targets can be at least ten times that of the density of the plurality of sensors. In some aspects, a density of the plurality of diffraction targets can be at least twenty times that of the density of the plurality of sensors. In some aspects, a density of the plurality of diffraction targets can be at least fifty times that of the density of the plurality of sensors. In some aspects, a density of the plurality of diffraction targets can be at least a hundred times that of the density of the plurality of sensors.

In some aspects, in a first mode, the apparatus can be configured to measure the plurality of diffraction targets sequentially. In some aspects, in the first mode, the metrology stage can move a first sensor of the sensor array over a first diffraction target of the plurality of diffraction targets based on a minimum distance between the first sensor and the first diffraction target. In some aspects, the apparatus can be further configured to determine the minimum distance based on an optimization algorithm. In some aspects, the optimization algorithm can consider relative distances between the plurality of sensors and the plurality of diffraction targets.

In some aspects, in a second mode, the apparatus can be configured to measure the plurality of diffraction targets simultaneously. In some aspects, in the second mode, the metrology stage can rotate at least first and second sensors of the sensor array over first and second diffraction targets of the plurality of diffraction targets, respectively, based on a relative rotation angle between the sensor array and the substrate. In some aspects, the apparatus can be further configured to determine the relative rotation angle based on an optimization algorithm. In some aspects, the optimization algorithm can consider relative rotations between the plurality of sensors and the plurality of diffraction targets for a range of 0 degrees to 45 degrees.

In some aspects, in a third mode, the apparatus can be configured to measure the plurality of diffraction targets on the substrate simultaneously. In some aspects, in the third mode, each sensor of the sensor array can have a field-of-view that is overlapping with neighboring sensors.

In some aspects, each sensor of the sensor array can include an integrated optic chip. In some aspects, the integrated optic chip can include an illumination source configured to provide an illumination beam. In some aspects, the integrated optic chip can include an optic configured to direct the illumination beam toward the diffraction target. In some aspects, the integrated optic chip can include a detector configured to detect the signal beam.

In some aspects, each sensor of the sensor array can include an integrated optical interconnect. In some aspects, the integrated optical interconnect can include an input waveguide configured to receive an illumination beam. In some aspects, the integrated optical interconnect can include an optical switch configured to direct the illumination beam toward the diffraction target and receive the signal beam. In some aspects, the integrated optical interconnect can include an output waveguide configured to transmit the signal beam.

In some aspects, the apparatus can further include a detector system including a detector. In some aspects, the detector system can be configured to collect the signal beam.

In some aspects, the apparatus can further include a processor. In some aspects, the processor can be coupled to the sensor array, the metrology stage, and the detector system. In some aspects, the processor can be configured to measure a characteristic of the diffraction target based on the signal beam. In some aspects, the characteristic of the diffraction target can be an alignment position. In some aspects, the characteristic of the diffraction target can be an overlay error.

In some aspects, the sensor array can overfill a surface area of the substrate. In some aspects, the sensor array can underfill a surface area of the substrate.

In some aspects, a detection system can include a sensor array, a metrology stage, and an optical coupler. In some aspects, the sensor array can include a plurality of sensors disposed over a plurality of diffraction targets on a substrate. In some aspects, each sensor of the sensor array can be configured to illuminate radiation to a diffraction target of the plurality of diffraction targets. In some aspects, each sensor of the sensor array can be configured to detect a signal beam including diffraction order sub-beams reflected from the diffraction target. In some aspects, the metrology stage can be coupled to the sensor array. In some aspects, the metrology stage can be configured to move the sensor array relative to the substrate. In some aspects, the optical coupler can be between the sensor array and the metrology stage. In some aspects, the sensor array can include the optical coupler. In some aspects, the metrology stage can include the optical coupler. In some aspects, the optical coupler can include a plurality of waveguides optically coupled to the plurality of sensors. In some aspects, the optical coupler can be configured to transmit the signal beam from each sensor to a plurality of fixed optical ports.

In some aspects, the detection system can include a plurality of optical couplers each having the plurality of sensors positioned at predetermined positions.

In some aspects, a lithographic apparatus can include an illumination system, a projection system, and a sensor apparatus. In some aspects, the illumination system can be configured to illuminate a patterning device. In some aspects, the projection system can be configured to project an image of the patterning device onto a substrate. In some aspects, the sensor apparatus can be configured to measure an overlay error of the lithographic apparatus. In some aspects, the sensor apparatus can include a sensor array including a plurality of sensors and a metrology stage. In some aspects, each sensor of the sensor array can be configured to illuminate radiation to a diffraction target on the substrate including a plurality of diffraction targets. In some aspects, each sensor of the sensor array can be configured to detect a signal beam including diffraction order sub-beams reflected from the diffraction target. In some aspects, the metrology stage can be coupled to the sensor array and can be configured to move the sensor array relative to the substrate. In some aspects, the sensor apparatus can be configured to measure the plurality of diffraction targets at a rate based on a density of the plurality of sensors relative to the plurality of diffraction targets.

In some aspects, the sensor apparatus can be configured to measure the plurality of diffraction targets at a rate of at least 10 diffraction targets per second. In some aspects, the sensor apparatus can be configured to measure the plurality of diffraction targets at a rate of at least 20 diffraction targets per second. In some aspects, the sensor apparatus can be configured to measure the plurality of diffraction targets at a rate of at least 30 diffraction targets per second. In some aspects, the sensor apparatus can be configured to measure the plurality of diffraction targets at a rate of at least 50 diffraction targets per second. In some aspects, the sensor apparatus can be configured to measure the plurality of diffraction targets at a rate of at least 100 diffraction targets per second.

In some aspects, the sensor apparatus can be configured to measure the plurality of diffraction targets at a rate of at least 100 ms per diffraction target. In some aspects, the sensor apparatus can be configured to measure the plurality of diffraction targets at a rate of at least 50 ms per diffraction target. In some aspects, the sensor apparatus can be configured to measure the plurality of diffraction targets at a rate of at least 20 ms per diffraction target. In some aspects, the sensor apparatus can be configured to measure the plurality of diffraction targets at a rate of at least 10 ms per diffraction target.

In some aspects, the lithographic apparatus can be configured to decrease the overlay error based on detection of higher spatial frequency deformations of the substrate.

In some aspects, a method of measuring a plurality of diffraction targets on a substrate can include measuring, by a sensor apparatus, signal beams from a plurality of diffraction targets on the substrate. In some aspects, the sensor apparatus can include a sensor array and a metrology stage coupled to the sensor array. In some aspects, each sensor of the sensor array can be configured to illuminate radiation to a diffraction target on the substrate, and detect a signal beam including diffraction order sub-beams reflected from the diffraction target. In some aspects, the metrology stage can be configured to move the sensor array relative to the substrate. In some aspects, the sensor apparatus can be configured to measure the plurality of diffraction targets at a rate based on a density of the plurality of sensors relative to the plurality of diffraction targets.

In some aspects, measuring can include sequentially measuring the plurality of diffraction targets. In some aspects, sequentially measuring can include translating a first sensor of the sensor array over a first diffraction target of the plurality of diffraction targets based on a minimum distance between the first sensor and the first diffraction target.

In some aspects, measuring can include simultaneously measuring the plurality of diffraction targets. In some aspects, simultaneously measuring can include rotating at least first and second sensors of the sensor array over first and second diffraction targets of the plurality of diffraction targets, respectively, based on a relative rotation angle between the sensor array and the substrate. In some aspects, simultaneously measuring can include overlapping a field-of-view of each sensor of the sensor array with neighboring sensors.

In some aspects, simultaneously measuring can include disposing the plurality of sensors at predetermined positions over each of the plurality of diffraction targets. In some aspects, simultaneously measuring can include detecting signal beams from each of the plurality of sensors through an optical coupler. In some aspects, the optical coupler can include a plurality of waveguides. In some aspects, the plurality of waveguides can be optically coupled to the plurality of sensors and a plurality of fixed optical ports.

In some aspects, the method can further include exchanging the sensor array and the optical coupler with a second sensor array and a second optical coupler configured to measure a plurality of diffraction targets on a second substrate.

Implementations of any of the techniques described above may include an EUV light source, a DUV light source, a system, a method, a process, a device, and/or an apparatus. The details of one or more implementations are set forth in the accompanying drawings and the description below. Other features will be apparent from the description and drawings, and from the claims.

Further features and exemplary aspects of the aspects, as well as the structure and operation of various aspects, are described in detail below with reference to the accompanying drawings. It is noted that the aspects are not limited to the specific aspects described herein. Such aspects are presented herein for illustrative purposes only. Additional aspects will be apparent to persons skilled in the relevant art(s) based on the teachings contained herein.

### BRIEF DESCRIPTION OF THE DRAWINGS

The accompanying drawings, which are incorporated herein and form part of the specification, illustrate the aspects and, together with the description, further serve to explain the principles of the aspects and to enable a person skilled in the relevant art(s) to make and use the aspects.

FIG. 1 is a schematic illustration of a lithographic apparatus, according to an exemplary aspect.

FIG. 2A is a schematic side illustration of an integrated optic chip, according to an exemplary aspect.

FIG. 2B is a schematic top perspective illustration of the integrated optic chip shown in FIG. 2A.

FIG. 3 is a schematic top perspective illustration of a substrate table for a substrate, according to an exemplary aspect.

FIG. 4 is a schematic top plan illustration of a substrate with a plurality of diffraction targets, according to an exemplary aspect.

FIG. 5 is a schematic side illustration of a sensor apparatus with a sensor array, according to an exemplary aspect.

FIG. 6 is a schematic top plan illustration of the sensor apparatus shown in FIG. 5.

FIG. 7 is a schematic top plan illustration of the sensor apparatus shown in FIG. 5 in a first mode, according to an exemplary aspect.

FIG. 8 is a schematic top plan illustration of the sensor apparatus shown in FIG. 5 in a second mode, according to an exemplary aspect.

FIG. 9 is a schematic side illustration of the sensor apparatus shown in FIG. 5 in a third mode with an overlapping sensor array, according to an exemplary aspect.

FIG. 10 is a schematic top plan illustration of the sensor apparatus shown in FIG. 9.

FIG. 11 is a schematic top plan illustration of the sensor apparatus shown in FIG. 5 with a congruent sensor array, according to an exemplary aspect.

FIG. 12 is a schematic top plan illustration of the sensor apparatus shown in FIG. 5 with an underfilled sensor array, according to an exemplary aspect.

FIG. 13 is a schematic top plan illustration of the sensor apparatus shown in FIG. 5 with a high density sensor array, according to an exemplary aspect.

FIG. 14 is a schematic top plan illustration of the sensor apparatus shown in FIG. 13 in a fourth mode, according to an exemplary aspect.

FIG. 15 is a schematic side illustration of a sensor apparatus with integrated optics, according to an exemplary aspect.

FIG. 16 is a schematic top perspective illustration of the sensor apparatus shown in FIG. 15.

FIG. 16A is a schematic top plan illustration of a sensor with an optical switch, according to an exemplary aspect.

FIG. 16B is schematic top plan illustration of a sensor with an optical switch, according to an exemplary aspect.

FIG. 17 is a schematic side illustration of a sensor apparatus with an optical coupler, according to an exemplary aspect.

FIG. 18 is a schematic top perspective illustration of the sensor apparatus shown in FIG. 17.

The features and exemplary aspects of the aspects will become more apparent from the detailed description set forth below when taken in conjunction with the drawings, in which like reference characters identify corresponding elements throughout. In the drawings, like reference numbers generally indicate identical, functionally similar, and/or structurally similar elements. Additionally, generally, the left-most digit(s) of a reference number identifies the drawing in which the reference number first appears. Unless otherwise indicated, the drawings provided throughout the disclosure should not be interpreted as to-scale drawings.

### DETAILED DESCRIPTION

This specification discloses one or more aspects that incorporate the features of this present invention. The disclosed aspect(s) merely exemplify the present invention. The scope of the invention is not limited to the disclosed aspect(s). The present invention is defined by the claims appended hereto.

The aspect(s) described, and references in the specification to “one aspect,” “an aspect,” “an example aspect,” “an exemplary aspect,” etc., indicate that the aspect(s) described may include a particular feature, structure, or characteristic, but every aspect may not necessarily include the particular feature, structure, or characteristic. Moreover, such phrases are not necessarily referring to the same aspect. Further, when a particular feature, structure, or characteristic is described in connection with an aspect, it is understood that it is within the knowledge of one skilled in the art to effect such feature, structure, or characteristic in connection with other aspects whether or not explicitly described.

Spatially relative terms, such as “beneath,” “below,” “lower,” “above,” “on,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

The term “about” or “substantially” or “approximately” as used herein indicates the value of a given quantity that can vary based on a particular technology. Based on the particular technology, the term “about” or “substantially” or “approximately” can indicate a value of a given quantity that varies within, for example, 1-15% of the value (e.g., ±1%, ±2%, ±5%, ±10%, or ±15% of the value).

Aspects of the disclosure may be implemented in hardware, firmware, software, or any combination thereof. Aspects of the disclosure may also be implemented as instructions stored on a machine-readable medium, which may be read and executed by one or more processors. A machine-readable medium may include any mechanism for storing or transmitting information in a form readable by a machine (e.g., a computing device). For example, a machine-readable medium may include read only memory (ROM); random access memory (RAM); magnetic disk storage media; optical storage media; flash memory devices; electrical, optical, acoustical or other forms of propagated signals (e.g., carrier waves, infrared signals, digital signals, etc.), and others. Further, firmware, software, routines, and/or instructions may be described herein as performing certain actions. However, it should be appreciated that such descriptions are merely for convenience and that such actions in fact result from computing devices, processors, controllers, or other devices executing the firmware, software, routines, instructions, etc.

Before describing such aspects in more detail, however, it is instructive to present example environments in which aspects of the present disclosure may be implemented.

### Exemplary Lithographic System

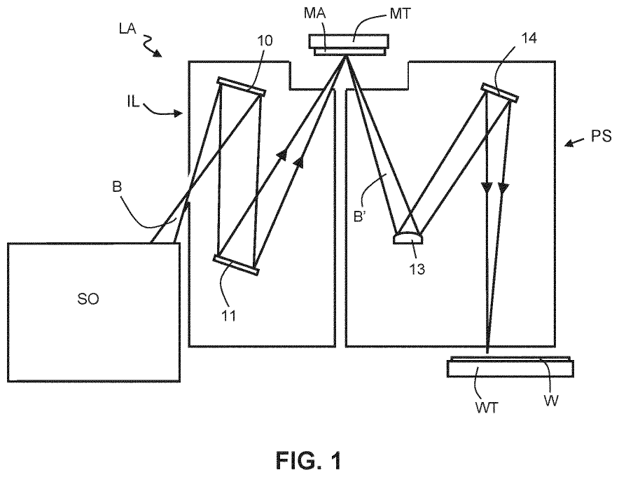

FIG. 1 shows a lithographic system comprising a radiation source SO and a lithographic apparatus LA. The radiation source SO is configured to generate an EUV and/or a DUV radiation beam B and to supply the EUV and/or DUV radiation beam B to the lithographic apparatus LA. The lithographic apparatus LA comprises an illumination system IL, a support structure MT (e.g., a mask table, a reticle table, a reticle stage) configured to support a patterning device MA (e.g., a mask, a reticle), a projection system PS, and a substrate table WT configured to support a substrate W.

The illumination system IL is configured to condition the EUV and/or DUV radiation beam B before the EUV and/or DUV radiation beam B is incident upon the patterning device MA. Thereto, the illumination system IL may include a faceted field mirror device 10 and a faceted pupil mirror device 11. The faceted field mirror device 10 and faceted pupil mirror device 11 together provide the EUV and/or DUV radiation beam B with a desired cross-sectional shape and a desired intensity distribution. The illumination system IL may include other mirrors or devices in addition to, or instead of, the faceted field mirror device 10 and faceted pupil mirror device 11.

After being thus conditioned, the EUV and/or DUV radiation beam B interacts with the patterning device MA. This interaction may be reflective (as shown), which may be preferred for EUV radiation. This interaction may be transmissive, which may be preferred for DUV radiation. As a result of this interaction, a patterned EUV and/or DUV radiation beam B′ is generated. The projection system PS is configured to project the patterned EUV and/or DUV radiation beam B′ onto the substrate W. For that purpose, the projection system PS may comprise a plurality of mirrors 13, 14 that are configured to project the patterned EUV and/or DUV radiation beam B′ onto the substrate W held by the substrate table WT. The projection system PS may apply a reduction factor to the patterned EUV and/or DUV radiation beam B′, thus forming an image with features that are smaller than corresponding features on the patterning device MA. For example, a reduction factor of 4 or 8 may be applied. Although the projection system PS is illustrated as having only two mirrors 13, 14 in FIG. 1, the projection system PS may include a different number of mirrors (e.g. six or eight mirrors).

The substrate W may include previously formed patterns. Where this is the case, the lithographic apparatus LA aligns the image, formed by the patterned EUV and/or DUV radiation beam B′, with a pattern previously formed on the substrate W.

### Exemplary Integrated Optic Chip

Compact direct measurement sensor systems provide improved accuracy, cost efficiency, and scalability. Compact sensors, on the order of about 10 mm×10 mm, for example, implemented on the same common platform, can form a sensor array of hundreds of sensors. These miniaturized sensors (e.g., 10 mm×10 mm) can measure a particular characteristic (e.g., alignment position, etc.) of an alignment mark on a substrate. Also, integration of components (e.g., illumination source, fibers, mirrors, lenses, waveguides, detectors, processor, etc.) in a single “on chip” sensor can improve miniaturization. Additionally, multiple alignment marks of the same substrate can be investigated by multiple sensors (e.g., sensor array) and different measurements can be conducted simultaneously or in real-time.

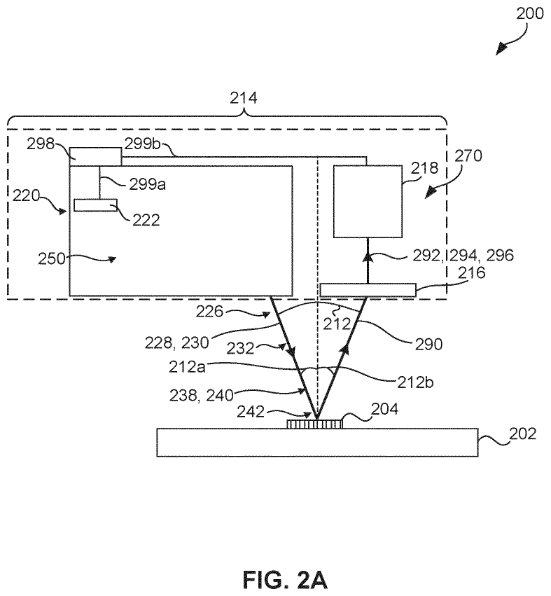

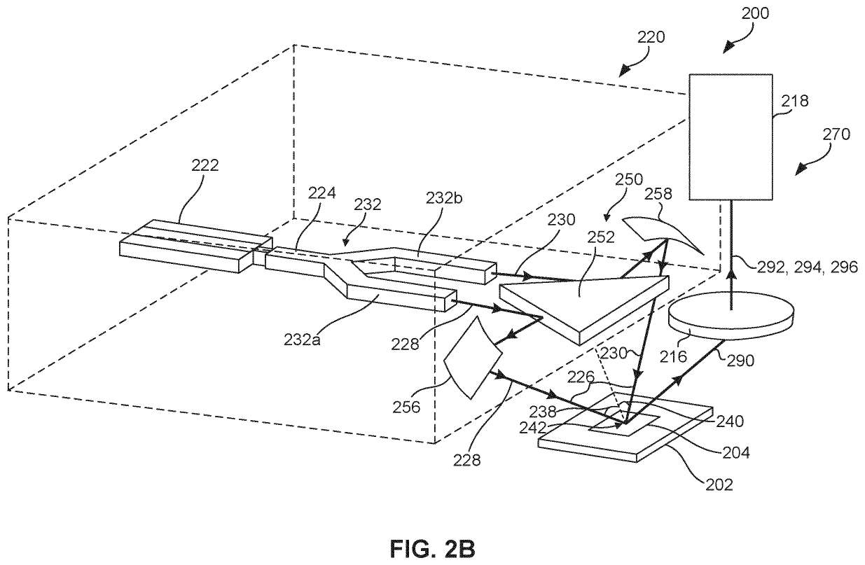

FIGS. 2A and 2B illustrate integrated optic chip 200, according to exemplary aspects. Integrated optic chip 200 can be configured to measure a characteristic (e.g., alignment position, overlay, etc.) of diffraction target 204 on substrate 202 and decrease errors (e.g., alignment, overlay) in a lithographic process, for example, in lithographic apparatus LA. Although integrated optic chip 200 is shown in FIGS. 2A and 2B as a stand-alone apparatus and/or system, aspects of this disclosure can be used with other apparatuses, systems, and/or methods, for example, lithographic apparatus LA, substrate table 300, patterned substrate 400, patterned substrate 400′, sensor apparatus 500, sensor apparatus 500′, and/or sensor apparatus 500″.

As shown in FIG. 2A, integrated optic chip 200 can include illumination system 220, detector system 270, and/or processor 298. Illumination system 220 can be configured to transmit illumination beam 226 along illumination path 232 toward diffraction target 204. In some aspects, illumination system 220 can form a fringe pattern 242 (e.g., a Moiré pattern) configured to provide structured illumination and act as a projected reference grating to investigate diffraction target 204 asymmetry by utilizing the Moiré effect. The Moiré effect is a large-scale interference effect that occurs when an opaque pattern with transparent gaps (e.g., parallel lines) is overlaid on another similar pattern.

As shown in FIG. 2B, illumination system 220 can include illumination source 222 (e.g., coherent), illumination coupling 224, illumination beam 226, first off-axis illumination beam 228, second off-axis illumination beam 230, illumination path 232, first angle of incidence 238, second angle of incidence 240, and/or adjustable optic 250. Illumination source 222 can produce illumination beam 226 and be coupled to illumination coupling 224, for example, by a fiber optic port or waveguide. In some aspects, illumination system 220 can include one or more waveguides or gratings to couple illumination beam 226 toward diffraction target 204.

In some aspects, illumination system 220 can be configured to provide a coherent electromagnetic broadband illumination beam 226 having one or more passbands. For example, the one or more passbands can be within a spectrum of wavelengths between about 500 nm to about 2000 nm. In some aspects, illumination system 220 can be further configured to provide one or more passbands having substantially constant center wavelength (CWL) values over a long period of time (e.g., over a lifetime of illumination system 220).

As shown in FIG. 2B, illumination coupling 224 can direct illumination beam 226 along illumination path 232 to diffraction target 204. Illumination coupling 224 (e.g., a waveguide) splits the illumination beam 226 from illumination source 222 into first off-axis illumination beam 228 and second off-axis illumination beam 230. Illumination path 232 can include first illumination path 232a and second illumination path 232b, for example, as shown in FIG. 2B. First off-axis illumination beam 228 can be directed along first illumination path 232a to diffraction target 204. Second off-axis illumination beam 230 can be directed along second illumination path 232b to diffraction target 204. First and second off-axis illumination beams 228, 230 (e.g., coherent) can be directed toward diffraction target 204 on substrate 202 disposed adjacent to illumination system 220.

In some aspects, for example, as shown in FIGS. 2A and 2B, first and second off-axis illumination beams 228, 230 (e.g., coherent) can generate fringe pattern 242 on diffraction target 204. First off-axis illumination beam 228 can be directed to diffraction target 204 at first angle of incidence 238, and second off-axis illumination beam 230 can be directed to diffraction target 204 at second angle of incidence 240. In some aspects, first and second off-axis illumination beams 228, 230 (e.g., coherent) can overlap and interfere to form a structured illumination, fringe pattern 242, since the beams are coherent. Fringe pattern 242 (e.g., a Moiré pattern) can operate as a projected reference grating on diffraction target 204.

Adjustable optic 250 can be configured to transmit first and second off-axis illumination beams 228, 230 toward diffraction target 204 on substrate 202. In some aspects, adjustable optic 250 can adjust first and second angles of incidence 238, 240, respectively, to adjust a periodicity of fringe pattern 242. For example, the periodicity of fringe pattern 242 can be proportional to first and second angles of incidence 238, 240. In some aspects, adjustable optic 250 can be configured to match a periodicity of diffraction target 204 with a periodicity of fringe pattern 242 by adjusting first and second angles of incidence 238, 240 to change the periodicity of fringe pattern 242. For example, when the periodicity of fringe pattern 242 is aligned with (e.g., matches) the periodicity of diffraction target 204, aberrations in integrated optic chip 200 do not alter signal beam 290 detected by detector system 270.

Adjustable optic 250 can include any optic (e.g., mirror, lens, prism, waveguide, optical modulator, etc.). In some aspects, adjustable optic 250 can be capable of altering first and second angles of incidence 238, 240 of first and second off-axis illumination beams 228, 230. For example, as shown in FIG. 2B, adjustable optic 250 can include adjustable prism mirror 252 and first and second off-axis mirrors 256, 258.

As shown in FIG. 2B, adjustable optic 250 can include adjustable prism mirror 252, first off-axis mirror 256, and second off-axis mirror 258. Adjustable prism mirror 252 can be configured to adjust a position of first and second off-axis illumination beams 228, 230 by adjusting a position of adjustable prism mirror 252 relative to illumination beam 226. For example, adjustable prism mirror 252 can translate toward or away from illumination coupling 224 or rotate or tilt with respect to illumination coupling 224 to alter a spot position of first and second coherent off-axis illumination beams 228, 230 on first and second off-axis mirrors 256, 258, respectively. In some aspects, by adjusting a position of adjustable prism mirror 252 relative to illumination beam 226, first and second angles of incidence 238, 240 of first and second off-axis illumination beams 228, 230, respectively, can be changed such that a periodicity of fringe pattern 242 is proportionally changed. In some aspects, adjustable prism mirror 252 can be adjusted (e.g., translated, rotated, tilted, etc.) to adjust a periodicity of fringe pattern 242 to match the periodicity of diffraction target 204. In some aspects, first and second off-axis mirrors 256, 258 can be fixed and be configured to reflect first and second off-axis illumination beams 228, 230, respectively, toward diffraction target 204.

In some aspects, adjustable prism mirror 252 can include a microelectromechanical system (MEMS)-based actuator and be configured to adjust first and second illumination paths 232a, 232b and first and second angles of incidence 238, 240 of first and second off-axis illumination beams 228, 230, respectively. For example, MEMS-based actuator of adjustable prism mirror 252 can control a focal spot of first and second off-axis illumination beams 228, 230 on diffraction target 204. In some aspects, first and/or second off-axis mirrors 256, 258 can be a flat, angled, parabolic, or elliptical mirror. For example, as shown in FIG. 2B, first and second off-axis mirrors 256, 258 can be parabolic. In some aspects, first and/or second off-axis mirrors 256, 258 can be adjustable. For example, first and/or second off-axis mirrors 256, 258 can each include a MEMS-based actuator.

In some aspects, first angle of incidence 238 and second angle of incidence 240 can be the same. In some aspects, first and second off-axis illumination beams 228, 230 can be focused beams on diffraction target 204. For example, adjustable optic 250 can include focusing optics, for example, first and second off-axis mirrors 256, 258 optimized for a focal length of about 1 mm or less. In some aspects, first and second coherent off-axis illumination beams 228, 230 can be defocused beams on diffraction target 204.

First and second off-axis illumination beams 228, 230 from illumination source 222 can transmit toward diffraction target 204 on substrate 202, disposed adjacent to illumination system 220, and generate signal beam 290. Signal beam 290 can include diffraction order sub-beams diffracted from diffraction target 204. For example, as shown in FIGS. 2A and 2B, signal beam 290 can include first diffraction order sub-beam 292, second diffraction order sub-beam 294, and third diffraction order sub-beam 296.

In some aspects, first diffraction order sub-beam 292 can be a negative diffraction order sub-beam (e.g., −1), second diffraction order sub-beam 294 can be a positive diffraction order sub-beam (e.g., +1), and third diffraction order sub-beam 296 can be a zeroth diffraction order sub-beam (e.g. 0). As shown in FIGS. 2A and 2B, first, second, and third diffraction order sub-beams 292, 294, 296 can be transmitted toward detector system 270, for example, toward fixed optic 216 and detector 218.

Detector system 270 can be configured to collect signal beam 290. As shown in FIGS. 2A and 2B, detector system 270 can include fixed optic 216 and detector 218. Fixed optic 216 can be configured to collect signal beam 290 and transmit signal beam 290 toward detector 218. Detector 218 can be configured to detect first, second, and/or third diffraction order sub-beams 292, 294, 296 of signal beam 290. In some aspects, fixed optic 216 can be a low numerical aperture (NA) lens. For example, fixed optic 216 can have an NA of about 0.1 to about 0.4. In some aspects, fixed optic 216 can be achromatic lens. For example, fixed optic 216 can be an achromatic doublet. In some aspects, detector system 270 can be configured to measure a characteristic of diffraction target 204 based on signal beam 290. In some aspects, the characteristic of diffraction target 204 measured by detector system 270 is an alignment position. In some aspects, the characteristic of diffraction target 204 measured by detector system 270 is an overlay. In some aspects, detector 218 can be a photodetector, photodiode, charge-coupled device (CCD), avalanche photodiode (APD), camera, PIN detector, multi-mode fiber, single-mode fiber, or any other suitable optical detector.

In some aspects, diffraction target 204 can be an alignment mark. In some aspects, substrate 202 can be supported by a stage and centered along an alignment axis. In some aspects, diffraction target 204 on substrate 202 can be a 1-D grating, which is printed such that after development, bars are formed of solid resist lines. In some aspects, diffraction target 204 can be a 2-D array or grating, which is printed such that, after development, a grating is formed of solid resist pillars or vias in the resist. For example, bars, pillars, or vias can alternatively be etched into substrate 202.

Processor 298 can be configured to measure a characteristic of diffraction target 204 based on signal beam 290. In some aspects, processor 298 can be integrated with detector system 270, illumination system 220, or external to detector system 270 and illumination system 220. For example, as shown in FIG. 2A, processor 298 can be disposed on a top surface of illumination system 220. As shown in FIG. 2A, processor 298 can include first control signal 299a and/or second control signal 299b. First control signal 299a can be configured to send and receive data between illumination source 222 and processor 298. Second control signal 299b can be configured to send and receive data between detector 218 and processor 298. Processor 298 can be coupled to illumination system 220 via first control signal 299a. Processor 298 can be coupled to detector system 270 via second control signal 299b. In some aspects, control signals 299a, 299b can be coupled to illumination system 220 and/or detector system 270 via optical fibers.

In some aspects, processor 298 can be configured to measure a characteristic of diffraction target 204 based on signal beam 290. For example, the characteristic of diffraction target 204 measured by processor 298 can be an alignment position or an overlay.

In some aspects, as shown in FIG. 2A, processor 298 can be integrated on illumination system 220. In some aspects, processor 298 can be external to detector system 270 and coupled to detector system 270, for example, by a fiber optic cable. In some aspects, processor 298 can be external to illumination system 220 and coupled to illumination system 220, for example, by a fiber optic cable.

In some aspects, illumination system 220 and detector system 270 can be separated by displacement angle 212. For example, displacement angle 212 can be configured to be about 1 degrees to about 5 degrees. As shown in FIG. 2A, displacement angle 212 can include first displacement angle 212a between illumination system 220 and an axis perpendicular to diffraction target 204, and second displacement angle 212b between detector system 270 and the axis perpendicular to diffraction target 204. In some aspects, first and second displacement angles 212a, 212b are equal. In some aspects, integrated optic chip 200 can be configured to be a compact system. In some aspects, as shown in FIG. 2, longitudinal area 214 of integrated optic chip 200 can be about 10 mm×10 mm. In some aspects, longitudinal area 214 of integrated optic chip 200 can be about 20 mm×20 mm.

### Exemplary Substrate Table and Patterned Substrate

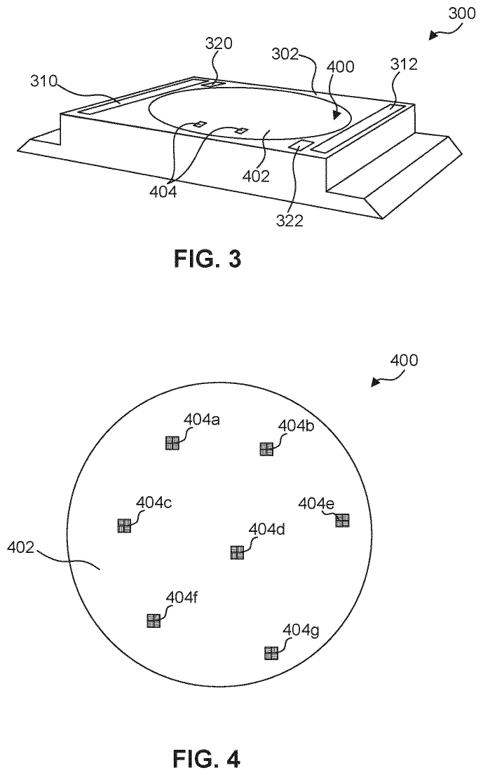

FIGS. 3 and 4 illustrate substrate table 300 and patterned substrate 400, according to exemplary aspects. Substrate table 300 can be configured to measure a characteristic (e.g., alignment position, pitch, diffraction order, depth, sub-segmentation, etc.) of one or more diffraction targets 404 on substrate 402 of patterned substrate 400, and thereby improve alignment and calibration (e.g., shift-between-orders (SBO) calibration), for example, in lithographic apparatus LA. Although substrate table 300 is shown in FIG. 3 as a stand-alone apparatus and/or system, aspects of this disclosure can be used with other apparatuses, systems, and/or methods, for example, lithographic apparatus LA, substrate table WT, integrated optic chip 200, patterned substrate 400, patterned substrate 400′, sensor apparatus 500, sensor apparatus 500′, and/or sensor apparatus 500″.

As shown in FIG. 3, substrate table 300 can include plate 302 configured to support patterned substrate 400. Plate 302 can include first alignment mark 310, second alignment mark 312, third alignment mark 320, and/or fourth alignment mark 322. In some aspects, for example, first alignment mark 310 can include a position alignment mark. In some aspects, for example, second alignment mark 312 can include a pitch alignment mark. In some aspects, for example, third alignment mark 320 can include a sub-segmentation alignment mark. In some aspects, for example, fourth alignment mark 322 can include a depth alignment mark. In some aspects, first, second, third, and fourth alignment marks 310, 312, 320, 322 can include a transmission sensor image (TIS) mark, an integrated lens interferometer at scanner (ILIAS) mark, a parallel integrated lens interferometer at scanner (PARIS) mark, and/or some combination thereof.

In some aspects, calibration (e.g., SBO calibration) of patterned substrate 400 can be conducted by measuring a difference between diffraction target(s) 404 and first, second, third, and/or fourth alignment marks 310, 312, 320, 322. For example, a measured position (e.g., absolute position, relative position, pitch, diffraction order, sub-segmentation, depth, etc.) of first, second, third, and/or fourth alignment marks 310, 312, 320, 322 can be compared to a measured position (e.g., absolute position, relative position, pitch, diffraction order, sub-segmentation, depth, etc.) of diffraction target 404, and an error difference can be determined and calibrated, for example, by a processor (not shown), sensor apparatus (not shown), and/or lithographic apparatus LA.

FIG. 4 illustrates patterned substrate 400, according to an exemplary aspect. Patterned substrate 400 can be configured to be patterned by a patterning device (e.g., a reticle) in a lithographic process, for example, in lithographic apparatus LA. Patterned substrate 400 can be configured to have one or more diffraction targets for calibration (e.g., alignment, overlay). Although patterned substrate 400 is shown in FIG. 4 as a stand-alone apparatus and/or system, aspects of this disclosure can be used with other apparatuses, systems, and/or methods, for example, lithographic apparatus LA, integrated optic chip 200, substrate table 300, patterned substrate 400′, sensor apparatus 500, sensor apparatus 500′, and/or sensor apparatus 500″.

As shown in FIG. 4, patterned substrate 400 can include substrate 402 and diffraction targets 404a-404g. In some aspects, substrate 402 can be a wafer. For example, the wafer can have a diameter of 100 mm, 200 mm, 300 mm, and/or 450 mm. In some aspects, substrate 402 can include any suitable material having a predetermined crystallographic orientation, including but not limited to silicon, germanium, and III-V semiconductors. Diffraction targets 404a-404g can be configured to calibrate (e.g., align) patterned substrate 400, for example, relative to a lithographic apparatus (e.g., lithographic apparatus LA). In some aspects, diffraction targets 404a-404g can include an alignment mark, an overlay mark, and/or a combination thereof. In some aspects, diffraction targets 404a-404g can include a TIS mark, an ILIAS mark, a PARIS mark, and/or some combination thereof. In some aspects, diffraction targets 404a-404g can be arranged symmetrically on substrate 402. In some aspects, as shown in FIG. 4, diffraction targets 404a-404g can be arranged asymmetrically (e.g., random, custom, etc.) on substrate 402. In some aspects, patterned substrate 400 can be disposed on plate 302. In some aspects, plate 302 can be disposed over patterned substrate 400. In some aspects, patterned substrate 400 can be disposed adjacent to plate 302.

### Exemplary Sensor Apparatuses

As discussed above, in order to control a lithographic process to form device features accurately on a substrate, one or more diffraction targets (e.g., alignment marks, overlay marks) are provided on the substrate. A lithographic apparatus uses one or more sensors (e.g., alignment sensors, overlay sensors, and/or combination of both) that accurately measures a characteristic (e.g., position, overlay) of the diffraction target.

Existing alignment systems and techniques are subject to certain drawbacks and limitations. For example, prior systems utilize a single sensor head and are in general relatively slow and bulky. Further, prior sensors take significant time to move from one target to the next and, thus, during operation the sensors spend most of the time idling (e.g., about 85% of the time per measurement). In addition, there are limitations in the speed (e.g., about 3 m/s) sensors can translate from one target to the next, and limitations in the required dwell time per measurement (e.g., about 10 ms). The dwell time is largely dependent upon the size of the sensor.

Compact systems can increase accuracy, yield, cost efficiency, and scalability and decrease errors in a lithographic process since hundreds of sensors can be implemented in a sensor array on the same common platform. Integration of components (e.g., illumination source, fibers, lenses, waveguides, detectors, processors, etc.) can provide a miniaturized sensor array for measuring particular characteristics (e.g., alignment, overlay) of one or more diffraction targets on the substrate, sequentially or in parallel. Multiple diffraction targets of the same substrate can be investigated simultaneously with a single sensor array (e.g., 5×5 array, 10×10 array, 25×25 array, 50×50 array, 100×100 array, 500×500 array, 1,000×1,000 array, etc.). Additionally, integrated optics can provide customized patterns (e.g., optically coupled waveguides) for corresponding diffraction target geometries (e.g., different field sizes), allowing for simultaneous measurement of all relevant diffraction targets on the substrate, thus increasing speed and accuracy.

Aspects of sensor apparatuses, systems, and methods as discussed below can provide a reduced footprint and compact sensor array that is scalable, increase accuracy and speed of measuring diffraction targets on a substrate, increase the number of diffraction targets that can be measured in a given time (e.g., at least 300 targets), increase a density of the sensors relative to the diffraction targets, decrease idling time, decrease errors in a lithographic process, and increase fabrication throughput and yield of a lithographic process.

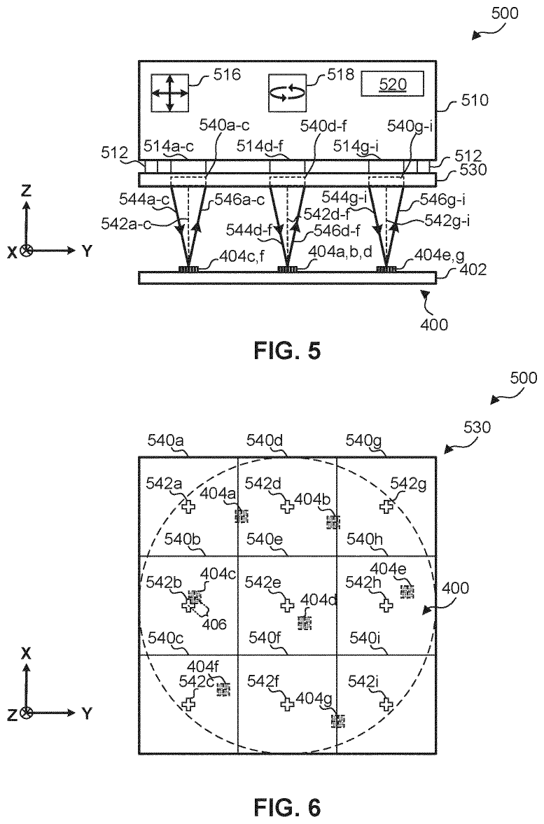

FIGS. 5-14 illustrate sensor apparatus 500, according to various exemplary aspects. Sensor apparatus 500 can be configured to illuminate a diffraction target 404a-404g on patterned substrate 400 and detect a signal beam 546a-546i including diffraction order sub-beams reflected from the diffraction target 404a-404g. Sensor apparatus 500 can be further configured to measure diffraction targets 404a-404g sequentially. Sensor apparatus 500 can be further configured to measure diffraction targets 404a-404g in parallel (simultaneously). Sensor apparatus 500 can be further configured to increase a rate (e.g., at least 30 targets per second) of measuring diffraction targets 404a-404b on patterned substrate 400. Sensor apparatus 500 can be further configured to decrease idling time and increase the number of diffraction targets 404a-404g that can be measured in a given time (e.g., at least 300 targets at 50 targets per second). Sensor apparatus 500 can be further configured to increase a density of sensors 540a-540i relative to diffraction targets 404a-404g (e.g., at least 10×). Although sensor apparatus 500′ is shown in FIGS. 5-14 as a stand-alone apparatus and/or system, aspects of this disclosure can be used with other apparatuses, systems, and/or methods, for example, lithographic apparatus LA, integrated optic chip 200, substrate table 300, patterned substrate 400, patterned substrate 400′, sensor apparatus 500′, and/or sensor apparatus 500″.

As shown in FIGS. 5 and 6, sensor apparatus 500 can include metrology stage 510, processor 520, and sensor array 530. Metrology stage 510 can be coupled to sensor array 530 and configured to move (e.g., translate, rotate, and/or focus) sensor array 530 relative to patterned substrate 400. Metrology stage 510 can be further configured to receive and process signal beams 546a-546i from sensor array 530. As shown in FIG. 5, metrology stage 510 can include mechanical coupling 512, optical ports 514a-514i, linear actuator 516, rotary actuator 518, and/or processor 520.

Mechanical coupling 512 can be configured to support sensor array 530 over patterned substrate 400 and couple sensor array 530 to metrology stage 510. In some aspects, mechanical coupling 512 can include one or more electrical connections (e.g., ports) to provide electrical signals (e.g., power, data, etc.) to and from sensor array (e.g., via processor 520). In some aspects, mechanical coupling 512 can be omitted and sensor array 530 can be directly coupled to metrology stage 510.

Optical ports 514a-514i can be configured to transmit and/or receive one or more optical signals (e.g., illumination beam 544a-i, signal beam 546a-546i) to and from sensor array 530 (e.g., via processor 520). In some aspects, optical ports 514a-514i can be fixed (in position) on metrology stage 510. In some aspects, optical ports 514a-514i can provide illumination beams 544a-544i to sensors 540a-540i of sensor array 530, respectively. In some aspects, optical ports 514a-514i can receive signal beams 546a-546i from sensors 540a-540i of sensor array 530, respectively. In some aspects, optical ports 514a-514i can include one or more detectors coupled to processor 520. For example, optical ports 514a-514i can be an optical detector (e.g., similar to detector system 270 with detector 218 shown in FIGS. 2A and 2B). In some aspects, optical ports 514a-514i can include one or more waveguides to optically couple to sensors 540a-540i of sensor array 530. In some aspects, optical ports 514a-514i can be part of a detector system (e.g., coupled to processor 520) configured to collect signal beams 546a-546i from sensor array 530. For example, optical ports 514a-514i can be coupled to one or more detectors within metrology stage 510 (e.g., similar to detector system 270 shown in FIGS. 2A and 2B).

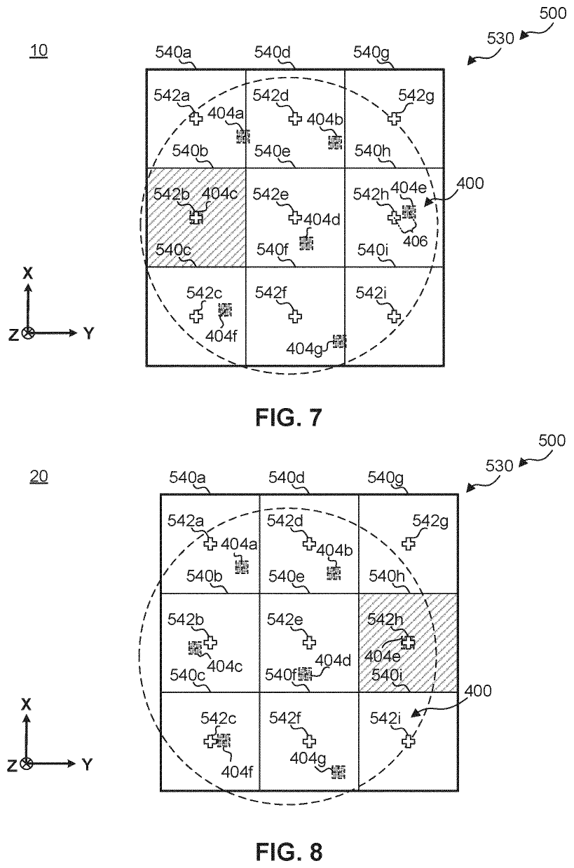

Linear actuator 516 can be configured to move (e.g., translate and/or focus) sensor array 530 relative to patterned substrate 400. In some aspects, linear actuator 516 can move sensor array 530 in three-dimensions (XYZ-axes) relative to patterned substrate 400. In some aspects, linear actuator 516 can include a motor, a stepper, a servomotor, or any other suitable actuator capable of translating in three-dimensions (XYZ-axes). In some aspects, linear actuator 516 can be controlled by processor 520, for example, to translate (e.g., XY-axes) and/or focus (e.g., Z-axis) one or more sensors 540a-540i of sensor array 530 to corresponding one or more diffraction targets 404a-404g on patterned substrate 400. For example, as shown in FIG. 7, in first mode 10, metrology stage 510 can translate sensor array 530 relative to patterned substrate 400 (e.g., XY-axes) such that sensor center 542b of sensor 540b is aligned over diffraction target 404c. For example, as shown in FIG. 8, in second mode 20, metrology stage 510 can translate sensor array 530 relative to patterned substrate 400 (e.g., XY-axes) such that sensor center 542h of sensor 540h is aligned over diffraction target 404e.

Rotary actuator 518 can be configured to rotate sensor array 530 relative to patterned substrate 400. In some aspects, rotary actuator 518 can rotate sensor array 530 (e.g., about Z-axis, R_{Z}) relative to patterned substrate 400. In some aspects, rotary actuator 518 can include a motor, a stepper, a servomotor, or any other suitable actuator capable of rotating about Z-axis, R_{Z}. In some aspects, rotary actuator 518 can be controlled by processor 520, for example, to rotate (e.g., about Z-axis, R_{Z}) one or more sensors 540a-540i of sensor array 530 to corresponding one or more diffraction targets 404a-404g on patterned substrate 400. For example, as shown in FIG. 14, in fourth mode 40, metrology stage 510 can rotate high density sensor array 530″″ relative to patterned substrate 400 (e.g., about Z-axis, R_{Z}) at relative rotation angle 532 (e.g., about 30°) such that sensor 540n₂₅ is aligned over diffraction target 404b and sensor 540n₃₈ is aligned over diffraction target 404e for simultaneous (parallel) measurements.

Processor 520 can be configured to control metrology stage 510 and sensor array 530. Processor 520 can be further configured to send and receive one or more control signals to and from metrology stage 510 (e.g., including optical ports 514a-514i, linear actuator 516, and/or rotary actuator 518) and sensor array 530. Processor 520 can be further configured to send illumination control signals and/or illumination beams 544a-544i to sensor array 530. Processor 520 can be further configured to send detection control signals to sensor array 530. Processor 520 can be further configured to receive and process signal beams 546a-546i from sensor array 530. In some aspects, processor can be electrically coupled and/or optically coupled to metrology stage 510 (e.g., including optical ports 514a-514i, linear actuator 516, and rotary actuator 518) and sensor array 530. In some aspects, processor 520 can be separate from metrology stage 510. In some aspects, as shown in FIG. 5, processor 520 can be included within metrology stage 510.

In some aspects, processor 520 can be configured to measure a characteristic of one or more diffraction targets 404a-404g based on collected signal beams 546a-546i from sensor array 530. For example, the characteristic can be an alignment position of one or more diffraction targets 404a-404g. For example, the characteristic can be an overlay error of one or more diffraction targets 404a-404g.

Sensor array 530 can be configured to illuminate one or more diffraction targets 404a-404g on patterned substrate 400 and detect corresponding signal beams 546a-546i including diffraction order sub-beams (e.g., similar to first, second, and third diffraction order sub-beams 292, 294, 296 shown in FIGS. 2A and 2B) reflected from the one or more diffraction targets 404a-404g. As shown in FIG. 5, sensor array 530 can include sensors 540a-540i with sensor centers 542a-542i. Sensors 540a-540i can apply one or more illumination beams 544a-544i toward corresponding diffraction targets 404a-404g (e.g., sequentially) on patterned substrate 400 and detect generated signal beams 546a-546i, respectively. In some aspects, sensor array 530 can receive illumination beams 544a-544i from metrology stage 510 (e.g., from an illumination source, via processor 520). In some aspects, sensor array 530 can send detected signal beams 546a-546i to processor 520 (e.g., via optical couplings, optical fibers, waveguides, etc.).

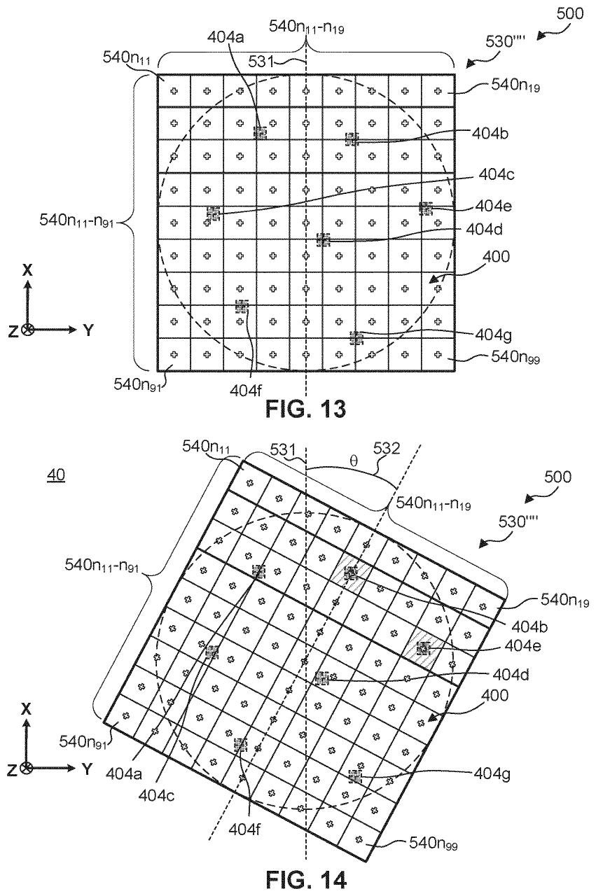

In some aspects, sensor array 530 can be an m×n array, where m=2, 3, 4, . . . , 1,000 and n=2, 3, 4, . . . , 1,000 (e.g., 20×30 array, 60×40 array, 100×100 array, 1,000×1,000 array, etc.). For example, as shown in FIG. 6, sensor array 530 can be a 3×3 array. For example, as shown in FIG. 13, high density sensor array 530″″ can be a 9×9 array. In some aspects, sensors 540a-540i of sensor array 530 can be arranged in a symmetric array (e.g., m×m array). For example, as shown in FIG. 6, sensors 540a-540i can be arranged in a 3×3 array. In some aspects, sensors 540a-540i of sensor array 530 can be arranged in an asymmetric array (e.g., m×n array, where m≠n). In some aspects, sensor array 530 can overfill underlying patterning substrate 400. For example, as shown in FIG. 6, sensor array 530 can have a rectangular shape (e.g., a square), for example, having a diagonal (e.g., 400 mm) that is greater than a diameter (e.g., 300 mm) of patterned substrate 400.

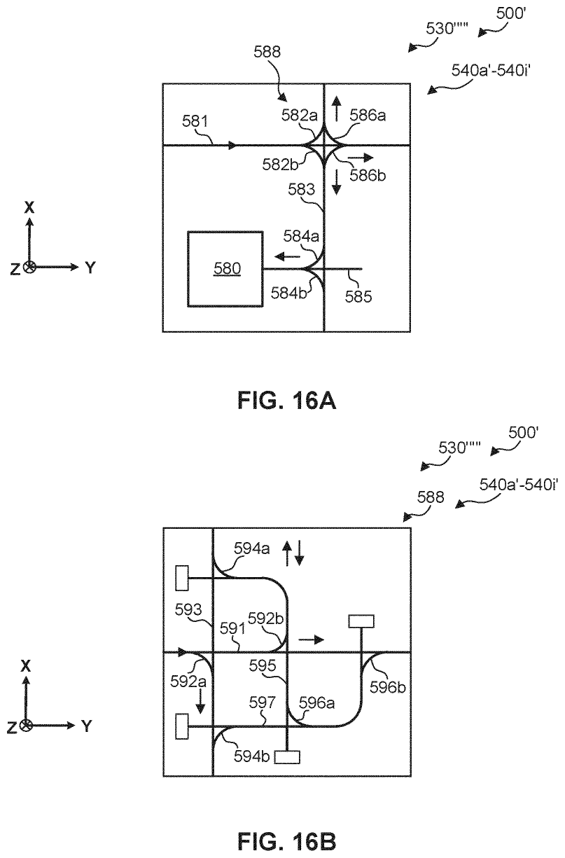

In some aspects, sensor array 530 can include one or more integrated optic chips. For example, sensor array 530 can include one or more integrated optic chips 200 shown in FIGS. 2A and 2B. In some aspects, each sensor 540a-540i of sensor array 530 can be integrated optic chip 200 shown in FIGS. 2A and 2B, which is independently controllable and coupled to processor 520. In some aspects, sensor array 530 can include one or more integrated optical interconnects. For example, as shown in FIG. 16, integrated optics sensor array 530′″″ can include input waveguides 552a-552i coupled to illumination source 550, optical switches 554a-554i directed to diffraction targets 404a-404g, and output waveguides 556a-556i coupled to detector 560.

In some aspects, sensor apparatus 500 can be configured to measure diffraction targets 404a-404g at a rate of at least 30 diffraction targets per second. For example, at a rate of 32 diffraction targets per second. In some aspects, sensor apparatus 500 can be configured to measure diffraction targets 404a-404g at a rate of at least 50 diffraction targets per second. For example, at a rate of 50 diffraction targets per second. In some aspects, sensor apparatus 500 can be configured to measure diffraction targets 404a-404g at a rate of at least 55 diffraction targets per second. For example, at a rate of 55 diffraction targets per second. In some aspects, sensor apparatus 500 can be configured to measure diffraction targets 404a-404g at a rate of at least 60 diffraction targets per second. For example, at a rate of 60 diffraction targets per second.

In some aspects, sensor apparatus 500 can be configured to measure diffraction targets 404a-404g at a rate based on a density of sensors 540a-540i relative to diffraction targets 404a-404g. For example, sensor apparatus 500 can measure diffraction targets at a rate of at least 30 diffraction targets per second based on a density of at least about 1:3 or 0.3× (e.g., 6×10 array for 200 targets). For example, sensor apparatus 500 can measure diffraction targets at a rate of at least 50 diffraction targets per second based on a density of at least about 1:2 or 0.5× (e.g., 10×10 array for 200 targets). For example, sensor apparatus 500 can measure diffraction targets at a rate of at least 55 diffraction targets per second based on a density of at least about 1:1.8 or 0.55× (e.g., 11×15 array for 300 targets). For example, sensor apparatus 500 can measure diffraction targets at a rate of at least 60 diffraction targets per second based on a density of at least about 1:1.6 or 0.6× (e.g., 12×15 array for 300 targets). For example, sensor apparatus 500 can measure diffraction targets at a rate of at least 100 diffraction targets per second based on a density of at least about 1:1 or 1× (e.g., 20×20 array for 400 targets).

In some aspects, sensor apparatus 500 can be configured to measure diffraction targets 404a-404g at a rate of at least 20 ms per diffraction target. In some aspects, sensor apparatus 500 can be configured to measure diffraction targets 404a-404g at a rate of at least 18 ms per diffraction target. In some aspects, sensor apparatus 500 can be configured to measure diffraction targets 404a-404g at a rate of at least 15 ms per diffraction target. In some aspects, sensor apparatus 500 can be configured to measure diffraction targets 404a-404g at a rate of at least 10 ms per diffraction target. In some aspects, sensor apparatus 500 can be configured to measure diffraction targets 404a-404g at a rate of at least 5 ms per diffraction target. In some aspects, sensor apparatus 500 can be configured to measure diffraction targets 404a-404g at a rate of at least 1 ms per diffraction target.

In some aspects, sensor apparatus 500 can be utilized in a lithographic apparatus and configured to measure an error of the lithographic apparatus. For example, sensor apparatus 500 can be utilized in lithographic apparatus LA shown in FIG. 1 to measure an overlay error on substrate W. In some aspects, sensor apparatus 500 can be configured to decrease an error in a lithographic process (e.g., in lithographic apparatus LA). For example, an overlay error can be decreased based on detection of higher spatial frequency deformations of patterned substrate 400 (e.g., for at least 300 targets).

In some aspects, a density of sensors 540a-540i is at least equal to a density of diffraction targets 404a-404g (e.g., 1:1 or 1×). For example, as shown in FIG. 18, the number of sensors 540a-540i of integrated optics sensor array 530″″″ and the number of diffraction targets 404a-404i on patterned substrate 400′ are equal (e.g., 3×3 array for 9 targets). In some aspects, a density of sensors 540a-540i is at least five times that of a density of diffraction targets 404a-404g (e.g., 5:1 or 5×), for example, 25×25 array for 125 targets. In some aspects, a density of sensors 540a-540i is at least ten times that of a density of diffraction targets 404a-404g (e.g., 10:1 or 10×), for example, 50×50 array for 250 targets.

In some aspects, each sensor 540a-540i of sensor array 530 can include an integrated optic chip. For example, the integrated optic chip can include integrated optic chip 200 shown in FIGS. 2A and 2B. In some aspects, each sensor 540a-540i of sensor array 530 can include an integrated optic chip including an illumination source configured to provide illumination beams 544a-544i, an optic configured to direct illumination beams 544a-544i toward diffraction targets 404a-404g, and a detector configured to detect signal beams 546a-546i. For example, the integrated optic chip can include integrated optic chip 200 shown in FIGS. 2A and 2B with illumination system 220, adjustable optic 250, and detection system 270.

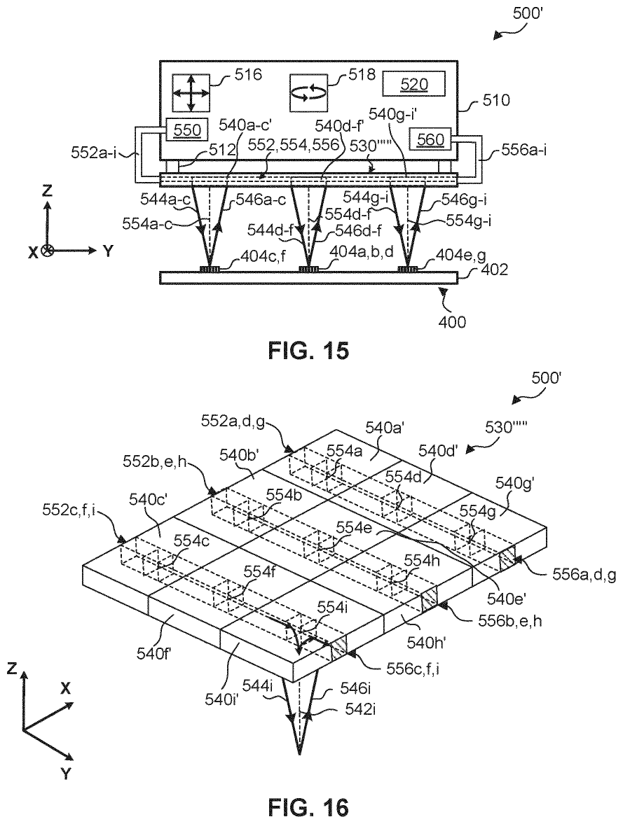

In some aspects, each sensor 540a-540i of sensor array 530 can include an integrated optical interconnect. For example, as shown in FIGS. 15 and 16, sensor apparatus 500′ can include integrated optics sensor array 530′″″ optically coupled to illumination source 550 and detector 560. In some aspects, each sensor 540a-540i of sensor array 530 can include an integrated optical interconnect including an input waveguide configured to receive illumination beams 544a-544i, an optical switch configured to direct illumination beams 544a-544i toward diffraction targets 404a-404g and receive signal beams 546a-546i, and an output waveguide configured to transmit signal beams 546a-546i. For example, as shown in FIGS. 15 and 16, sensor apparatus 500′ can include integrated optics sensor array 530′″″ with input waveguides 552a-552i, optical switches 554a-554i, and output waveguides 556a-556i, respectively.

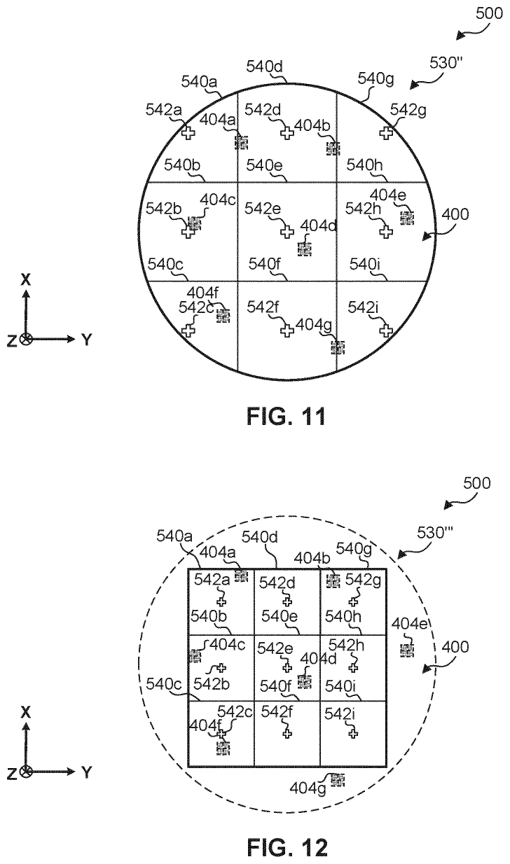

In some aspects, sensor array 530 can overfill a surface area of patterned substrate 400. For example, as shown in FIG. 6, sensor array 530 overfills (extends beyond) an exterior of patterned substrate 400. In some aspects, sensor array 530 can exactly fill a surface area of patterned substrate 400. For example, as shown in FIG. 11, congruent sensor array 530″ is congruent (equal) to an exterior of patterned substrate 400. In some aspects, sensor array 530 can underfill a surface area of patterned substrate 400. For example, as shown in FIG. 12, underfilled sensor array 530′″ underfills (contained within) an exterior of patterned substrate 400.

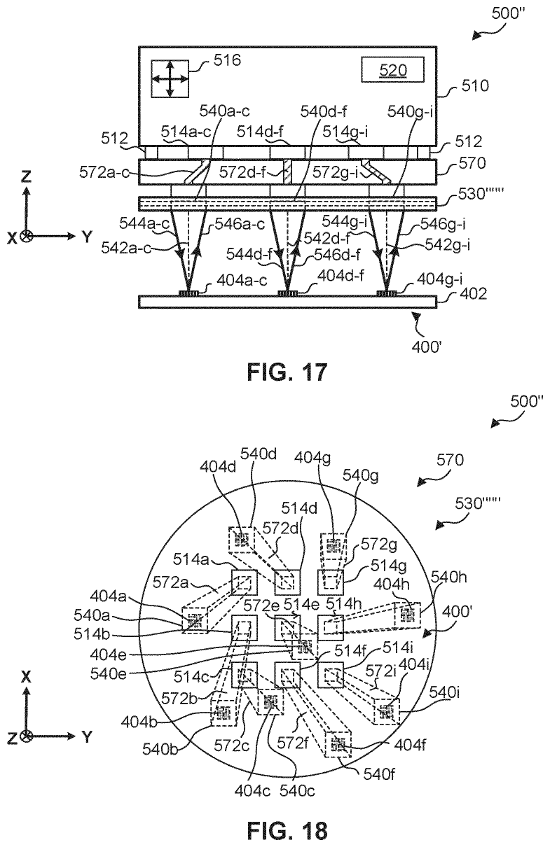

In some aspects, sensor apparatus 500 can include an optical coupler between sensor array 530 and metrology stage 510, the optical coupler configured to transmit signal beams 546a-546i from each sensor 540a-540i to optical ports 514a-514i, respectively. For example, as shown in FIGS. 17 and 18, sensor apparatus 500″ can include optical coupler 570 having waveguides 572a-572i optically coupled to sensors 540a-540i and optical ports 514a-514i (fixed), respectively. In some aspects, sensor apparatus 500 can include a plurality of optical couplers, each having sensors 540a-540i positioned at predetermined (customized) positions, that can be exchanged individually between sensor array 530 and metrology stage 510 for respective patterned substrates 400.

FIG. 7 illustrates sensor apparatus 500 in a first mode 10, according to an exemplary aspect. As shown in FIGS. 6 and 7, sensor apparatus 500 can be configured to measure diffraction targets 404a-404g sequentially such that metrology stage 510 moves (e.g., in XY-axes) sensor 540b of sensor array 530 over diffraction target 404c based on a minimum distance 406 between sensor 540b and diffraction target 404c. As shown in FIG. 7, in first mode 10, sensor center 542b of sensor 540b is aligned over diffraction target 404c.

FIG. 8 illustrates sensor apparatus 500 in a second mode 20, according to an exemplary aspect. As shown in FIGS. 7 and 8, sensor apparatus 500 can be configured to measure diffraction targets 404a-404g sequentially such that, after measuring diffraction target 404c with sensor 540b in first mode 10 shown in FIG. 7, metrology stage 510 moves (e.g., in XY-axes) sensor 540h of sensor array 530 over diffraction target 404e based on a minimum distance 406 between sensor 540h and diffraction target 404e. As shown in FIG. 8, in second mode 20, sensor center 542h of sensor 540h is aligned over diffraction target 404e.

In some aspects, sensor apparatus 500 can be further configured to determine minimum distance 406 based on an optimization algorithm (e.g., via processor 520) that considers relative distances between all sensors 540a-540i and all diffraction targets 404a-404g. For example, the optimization algorithm can utilize gradient descent, linear regression, neural network, finite difference, or any other algorithm sufficient to determine the minimum distance 406. In some aspects, the optimization algorithm can further determine an optimized sequence of minimum distances 406 and corresponding sequential order of measurements of diffraction targets 404a-404g.

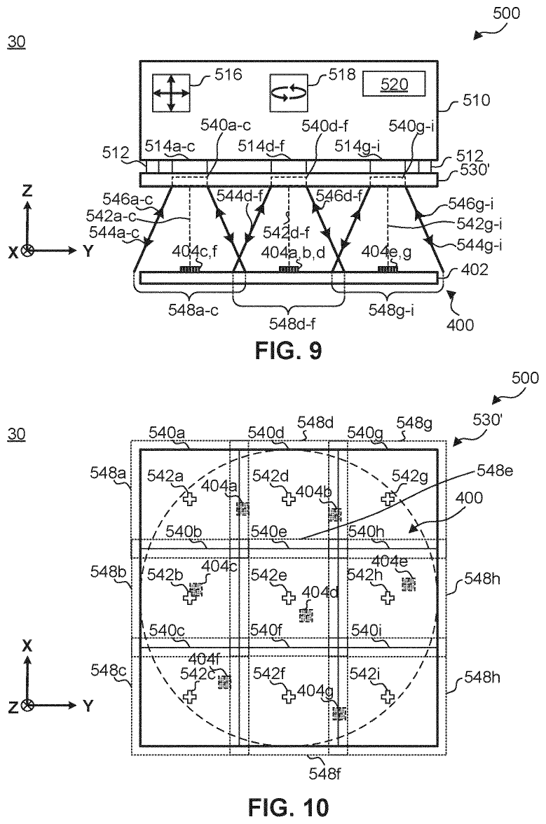

FIGS. 9 and 10 illustrate sensor apparatus 500 in a third mode 30 with an overlapping sensor array 530′, according to exemplary aspects. Overlapping sensor array 530′ can be configured to measure diffraction targets 404a-404g simultaneously. Overlapping sensor array 530′ can be further configured such that each sensor 540a-540i has an overlapping field-of-view 548a-548i that is overlapping with neighboring sensors.

The aspects of sensor array 530 shown in FIGS. 5 and 6, for example, and the aspects of overlapping sensor array 530′ shown in FIGS. 9 and 10 may be similar. Similar reference numbers are used to indicate features of the aspects of sensor array 530 shown in FIGS. 5 and 6 and the similar features of the aspects of overlapping sensor array 530′ shown in FIGS. 9 and 10. As shown in FIGS. 9 and 10, overlapping sensor array 530′ includes overlapping fields-of-view 548a-548i enabling simultaneous (parallel) measurement of all diffraction targets 404a-404g rather than sensor array 530 that uses sequential measurement of diffraction targets 404a-404g shown in FIGS. 5 and 6.

As shown in FIGS. 9 and 10, in third mode 30, overlapping sensor array 530′ can include overlapping fields-of-view 548a-548i. A field-of-view is the observable area (e.g., solid angle) of an optical device, and is the maximum area the optical device can measure. Overlapping fields-of-view 548a-548i represent the maximum area that corresponding sensors 540a-540i can measure on patterned substrate 400. Overlapping fields-of-view 548a-548i can be configured to measure all diffraction targets 404a-404g on patterned substrate 400 simultaneously (parallel measurement), since each diffraction target 404a-404g is located within at least one overlapping field-of-view 548a-548i. As shown in FIGS. 9 and 10, each sensor 540a-540i of overlapping sensor array 530′ has an overlapping field-of-view 548a-548i that is overlapping with neighboring sensors. For example, as shown in FIG. 10, overlapping field-of-view 548a of sensor 540a overlaps (extends into) overlapping fields-of-view 548b, 548d, 548e of sensors 540b, 540d, 540e, respectively.

FIG. 11 illustrates sensor apparatus 500 with congruent sensor array 530″, according to an exemplary aspect. Congruent sensor array 530″ can be configured to match (equal) a shape of underlying patterned substrate 400.

The aspects of sensor array 530 shown in FIGS. 5 and 6, for example, and the aspects of congruent sensor array 530″ shown in FIG. 11 may be similar. Similar reference numbers are used to indicate features of the aspects of sensor array 530 shown in FIGS. 5 and 6 and the similar features of the aspects of congruent sensor array 530″ shown in FIG. 11. As shown in FIG. 11, congruent sensor array 530″ can be congruent (aligned) with underlying patterned substrate 400, having the same dimensions as patterned substrate 400 without any overfilling portions, rather than sensor array 530 that overfills underlying patterned substrate 400 shown in FIGS. 5 and 6.

As shown in FIG. 11, congruent sensor array 530″ can include a diameter equal to a diameter of patterned substrate 400. In some aspects, a surface area of congruent sensor array 530″ and a surface area of patterned substrate 400 can be equal. For example, as shown in FIG. 11, congruent sensor array 530″ can have a circular shape (e.g., a wafer shape), for example, having a diameter (e.g., 300 mm) matching that of patterned substrate 400.

FIG. 12 illustrates sensor apparatus 500 with underfilled sensor array 530′″, according to an exemplary aspect. Underfilled sensor array 530′″ can be configured to have a shape less than (within) a shape of underlying patterned substrate 400. Underfilled sensor array 530′″ can be further configured to provide a higher density of sensors 540a-540i relative to diffraction targets 404a-404g for specific areas on patterned substrate 400 (e.g., specific field sizes).

The aspects of sensor array 530 shown in FIGS. 5 and 6, for example, and the aspects of underfilled sensor array 530′″ shown in FIG. 12 may be similar. Similar reference numbers are used to indicate features of the aspects of sensor array 530 shown in FIGS. 5 and 6 and the similar features of the aspects of underfilled sensor array 530′″ shown in FIG. 11. As shown in FIG. 12, underfilled sensor array 530′″ can underfill underlying patterned substrate 400, having smaller dimensions than patterned substrate 400, rather than sensor array 530 that overfills underlying patterned substrate 400 shown in FIGS. 5 and 6.

As shown in FIG. 12, underfilled sensor array 530′″ can include a diameter (or diagonal) less than a diameter of patterned substrate 400. In some aspects, a surface area of underfilled sensor array 530′″ can be less than a surface area of patterned substrate 400. For example, as shown in FIG. 12, underfilled sensor array 530′″ can have a rectangular shape (e.g., a square), for example, having a diagonal (e.g., 250 mm) that is less than a diameter (e.g., 300) of patterned substrate 400.

FIGS. 13 and 14 illustrate sensor apparatus 500 with high density sensor array 530″″, according to exemplary aspects. High density sensor array 530″″ can be configured to provide a high density of sensors 540n₁₁-540n₉₉ (9×9 array) relative to diffraction targets 404a-404g (e.g., at least 1:1 or 1×, for example, 81:7 or 11.6×).

The aspects of sensor array 530 shown in FIGS. 5 and 6, for example, and the aspects of high density sensor array 530″″ shown in FIGS. 13 and 14 may be similar. Similar reference numbers are used to indicate features of the aspects of sensor array 530 shown in FIGS. 5 and 6 and the similar features of the aspects of high density sensor array 530″″ shown in FIGS. 13 and 14. As shown in FIGS. 13 and 14, high density sensor array 530″″ can include a high density of sensors 540n₁₁-540n₉₉ (9×9 array) to diffraction targets 404a-404g (e.g., 81:7 or 11.6×) that can be rotated relative to patterned substrate 400 rather than sensor array 530 (e.g., 3×3 array) with a lower sensor:target density (9:7 or 1.3×) shown in FIGS. 5 and 6.

As shown in FIGS. 13 and 14, high density sensor array 530″″ (9×9 array) can include sensors 540n₁₁-540n₉₉ with rows 540n₁₁-540n₉₁ and columns 540n₁₁-540n₁₉. In some aspects, high density sensor array 530″″ can be an m×n array, where m=4, 5, 6, . . . , 1,000 and n=4, 5, 6, . . . , 1,000 (e.g., 20×30 array, 60×40 array, 50×50 array, 100×100 array, 1,000×1,000 array, etc.). For example, as shown in FIG. 13, high density sensor array 530″″ can be a 9×9 array.

FIG. 14 illustrates sensor apparatus in a fourth mode 40, according to an exemplary aspect. As shown in FIGS. 13 and 14, sensor apparatus 500 can be configured to measure two or more diffraction targets 404a-404g simultaneously such that metrology stage 510 rotates (e.g., about Z-axis, R_{Z}) sensors 540n₂₅, 540n₃₈ of high density sensor array 530″″ over diffraction targets 404b, 404e, respectively, based on a relative rotation angle 532 between high density sensor array 530″″ and patterned substrate 400 (e.g., from central axis 531). As shown in FIG. 14, in fourth mode 40, after rotation to relative rotation angle 532, sensor 540n₂₅ is aligned over diffraction target 404b and sensor 540n₃₈ is aligned over diffraction target 404e and can be measured simultaneously by high density sensor array 530″″. In some aspects, relative rotation angle 532 can include a range from 0° to 45°. For example, as shown in FIG. 14, relative rotation angle 532 can be about 30°.

In some aspects, sensor apparatus 500 can be further configured to determine relative rotation angle 532 based on an optimization algorithm (e.g., via processor 520) that considers relative rotations between all sensors 540a-540i and all diffraction targets 404a-404g, respectively, for a range of 0° to 45°. For example, the optimization algorithm can utilize gradient descent, linear regression, neural network, finite difference, or any other algorithm sufficient to determine the relative rotation angle 532. In some aspects, the optimization algorithm can further determine an optimized sequence of relative rotation angles 532 and corresponding sequential order of simultaneous (parallel) measurements of diffraction targets 404a-404g.

Exemplary Sensor Apparatus with Integrated Optics

FIGS. 15 and 16 illustrate sensor apparatus 500′, according to exemplary aspects. Sensor apparatus 500′ can be configured to utilize integrated optics to form an optical routing network of sensors 540a′-540i′ for continuous, independently controllable measurement of one or more diffraction targets 404a-404g. Sensor apparatus 500′ can be further configured to utilize integrated optics sensor array 530′″″ having a wafer-scale profile and decreased dwell time (e.g., about 10 μs). Sensor apparatus 500′ can be further configured to utilize integrated optics sensor array 530′″″ formed from wafer-scale fabrication for increased density (e.g., sensor 540a′-540i′ unit cell dimensions of about 0.5 mm×0.5 mm) and decreased working-distance (e.g., no greater than about 10 mm). Although sensor apparatus 500′ is shown in FIGS. 15 and 16 as a stand-alone apparatus and/or system, aspects of this disclosure can be used with other apparatuses, systems, and/or methods, for example, lithographic apparatus LA, integrated optic chip 200, substrate table 300, patterned substrate 400, patterned substrate 400′, sensor apparatus 500, and/or sensor apparatus 500″.

The aspects of sensor apparatus 500 shown in FIGS. 5 and 6, for example, and the aspects of sensor apparatus 500′ shown in FIGS. 15 and 16 may be similar. Similar reference numbers are used to indicate features of the aspects of sensor apparatus 500 shown in FIGS. 5 and 6 and the similar features of the aspects of sensor apparatus 500′ shown in FIGS. 15 and 16. As shown in FIGS. 15 and 16, sensor apparatus 500′ includes integrated optics sensor array 530′″″ optically coupled to illumination source 550 and detector 560 rather than sensor array 530 of sensor apparatus 500 shown in FIGS. 5 and 6.

As shown in FIGS. 15 and 16, sensor apparatus 500′ can include integrated optics sensor array 500′″″ optically coupled to illumination source 550 and detector 560 of metrology stage 510 via input waveguides 552a-552i and output waveguides 556a-556i, respectively. Integrated optics sensor array 500′″″ can be configured to illuminate one or more diffraction targets 404a-404g on patterned substrate 400 and detect corresponding signal beams 546a-546i including diffraction order sub-beams (e.g., similar to first, second, and third diffraction order sub-beams 292, 294, 296 shown in FIGS. 2A and 2B) reflected from the one or more diffraction targets 404a-404g. In some aspects, integrated optics sensor array 500′″″ can be monolithic (e.g., single wafer). In some aspects, integrated optics sensor array 500′″″ can be fixed (e.g., thermally and/or mechanically anchored) to metrology stage 510 for decreased internal deformation drift (e.g., less than 0.1 nm drift). As shown in FIGS. 15 and 16, integrated optics sensor array 500′″″ can include sensors 540a′-540i′ in an optical routing network formed by input waveguides 552a-552i, optical switches 554a-554i, and output waveguides 556a-556i, respectively.

Input waveguides 552a-552i can be configured to transmit illumination beams 544a-544i from illumination source 550 to optical switches 554a-554i. As shown in FIG. 16, input waveguides 552a-552i can form an optical network optically connecting adjacent sensors 540a′-540i′. In some aspects, input waveguides 552a-552i can include silicon nitride, lithium niobate, or any other suitable material capable of transmitting illumination beams 544a-544i. In some aspects, input waveguides 552a-552i can be formed along one or two axes. For example, as shown in FIG. 16, input waveguides 552a-552i are formed along the Y-axis. In some aspects, input waveguides 552a-552i can be formed along both axes (e.g., XY-axes). In some aspects, input waveguides 552a-552i can include tapered waveguides for reduced stitching errors and misalignment losses (e.g., less than 4 mdB loss). For example, each input waveguide 552a-552i can include a tapered waveguide having a waveguide width at a distal (interconnecting) end of at least about 5 μm, while a proximal (body) portion can have a tapered waveguide width of about 1 μm.

Optical switches 554a-554i can be configured to receive illumination beams 544a-544i from input waveguides 552a-552i, direct illumination beams 544a-544i toward diffraction targets 404a-404g, receive signal beams 546a-546i from diffraction targets 404a-404g, and transmit signal beams 546a-546i to output waveguides 556a-556i. In some aspects, optical switches 554a-554i can include a MEMS optical switch. For example, optical switches 554a-554i can include a MEMS-actuated adiabatic coupler (e.g., 2-way optical switch). In some aspects, optical switches 554a-554i can include a 3-way optical switch. For example, optical switches 554a-554i can include three 1-way optical switches (e.g., MEMS optical switch) to form the 3-way optical switch. For example, optical switches 554a-554i can include two 2-way optical switches (e.g., MEMS optical switch) to form the 3-way optical switch. In some aspects, optical switch 554a-554i can have an insertion loss of less than about 0.2 dB and an extinction ratio of less than about 60 dB.

Output waveguides 556a-556i can be configured to receive signal beams 546a-546i from optical switches 554a-554i and transmit signal beams 546a-546i to detector 560. As shown in FIG. 16, output waveguides 556a-556i can form an optical network optically connecting adjacent sensors 540a′-540i′. In some aspects, output waveguides 556a-556i can include silicon nitride, lithium niobate, or any other suitable material capable of transmitting signal beams 546a-546i. In some aspects, output waveguides 556a-556i can be formed along one or two axes. For example, as shown in FIG. 16, output waveguides 556a-556i are formed along the Y-axis. In some aspects, output waveguides 556a-556i can be formed along both axes (e.g., XY-axes). In some aspects, output waveguides 556a-556i can include tapered waveguides for reduced stitching errors and misalignment losses (e.g., less than 4 mdB loss). For example, each output waveguide 556a-556i can include a tapered waveguide having a waveguide width at a distal (interconnecting) end of at least about 5 μm, while a proximal (body) portion can have a tapered waveguide width of about 1 μm.

In some aspects, illumination can be guided only to certain sensors 540a′-540i′. For example, particular illumination beams 544a-544i from illumination source 550 can be guided to corresponding sensors 540a′-540i′ such that not all sensors 540a′-540i′ are illuminated simultaneously, thereby conserving power and directing illumination to only those sensors 540a′-540i′ needed for a particular measurement. In some aspects, sensors 540a′-540i′ can be optically coupled to each other via one or more waveguides. For example, as shown in FIG. 16A, each sensor 540a′-540i′ can include first waveguide 581 (e.g., along Y-axis), second waveguide 583 (e.g., along X-axis), and optical switch network 588 to guide illumination (e.g., illumination beams 544a-544i and/or signal beams 546a-546i) to and from illumination and detector optics 580 of each respective sensor 540a′-540i′ and transfer (port) illumination between neighboring sensors 540a′-540i′. In some aspects, illumination and detection optics 580 can be configured to guide illumination beams 544a-544i to one or more diffraction targets 404a-404g on patterned substrate 400 and detect corresponding signal beams 546a-546i.

In some aspects, as shown in FIG. 16A, each sensor 540a′-540i′ can include illumination and detection optics 580, first waveguide 581 (e.g., Y-axis input, optically coupled to neighboring sensors 540a′-540i′ along the Y-axis), first optical switch 582a, second optical switch 582b, second waveguide 583 (e.g., X-axis input, optically coupled to neighboring sensors 540a′-540i′ along the X-axis), third optical switch 584a, fourth optical switch 584b, third waveguide 585 (e.g., optically coupled to illumination and detection optics 580), fifth optical switch 586a, and sixth optical switch 586b.

In some aspects, each sensor 540a′-540i′ can include a 3-way optical switch to guide light in three directions. For example, as shown in FIG. 16A, each sensor 540a′-540i′ can include an optical switch network 588 that can include, for example, two 2-way optical switches (e.g., first optical switch 582a and second optical switch 582b; third optical switch 584a and fourth optical switch 584b; fifth optical switch 586a and sixth optical switch 586b) to form the 3-way optical switch. In some aspects, optical switch network 588 can include one or more MEMS optical switches (e.g., MEMS-actuated adiabatic couplers). For example, as shown in FIG. 16A, first optical switch 582a, second optical switch 582b, third optical switch 584a, fourth optical switch 584b, fifth optical switch 586a, and sixth optical switch 586b can include a MEMS optical switch (e.g., MEMS-actuated adiabatic coupler).

In some aspects, as shown in FIG. 16B, optical switch network 588 can include first waveguide 591 (e.g., Y-axis input, optically coupled to neighboring sensors 540a′-540i′ along the Y-axis), first optical switch 592a, second optical switch 592b, second waveguide 593 (e.g., X-axis input, optically coupled to neighboring sensors 540a′-540i′ along the X-axis), third optical switch 594a, fourth optical switch 594b, third waveguide 595 (e.g., 90° local waveguide, Y-axis to negative X-axis), fifth optical switch 596a, sixth optical switch 596b, and fourth waveguide 597 (e.g., −90° local waveguide, Y-axis to positive X-axis). In some aspects, as shown in FIG. 16B, optical switch network 588 that can include, for example, three 1-way optical switches (e.g., first optical switch 592a, second optical switch 592b, and third optical switch 594a) to form a 3-way optical switch. In some aspects, optical switch network 588 can include one or more single optical switches (e.g., MEMS optical switches). For example, as shown in FIG. 16B, first optical switch 592a, second optical switch 592b, third optical switch 594a, fourth optical switch 594b, fifth optical switch 596a, and sixth optical switch 596b can include a MEMS optical switch.

Exemplary Sensor Apparatus with Optical Coupler

FIGS. 17 and 18 illustrate sensor apparatus 500″, according to exemplary aspects. Sensor apparatus 500″ can be configured to utilize an optical coupler 570 with waveguides 572a-572i as an exchangeable (swappable) optical routing network, optically coupling sensors 540a-540i located at predetermined positions to optical ports 514a-514i (fixed) of metrology stage 510 via waveguides 572a-572i. Sensor apparatus 500″ can be further configured to utilize optical coupler 570 having a wafer-scale profile and waveguides 572a-572i optically connecting predetermined (customized) sensor 540a-540i positions over corresponding diffraction targets 404a-404i on patterned substrate 400′, respectively. Sensor apparatus 500″ can be further configured to utilize (e.g., exchange) a plurality of optical couplers 570, each having sensors 540a-540i at different predetermined (customized) positions, and exchange a specific optical coupler 570 for a corresponding specific patterned substrate 400′. Although sensor apparatus 500″ is shown in FIGS. 17 and 18 as a stand-alone apparatus and/or system, aspects of this disclosure can be used with other apparatuses, systems, and/or methods, for example, lithographic apparatus LA, integrated optic chip 200, substrate table 300, patterned substrate 400, patterned substrate 400′, sensor apparatus 500, and/or sensor apparatus 500′.

The aspects of sensor apparatus 500 shown in FIGS. 5 and 6, for example, and the aspects of sensor apparatus 500″ shown in FIGS. 17 and 18 may be similar. Similar reference numbers are used to indicate features of the aspects of sensor apparatus 500 shown in FIGS. 5 and 6 and the similar features of the aspects of sensor apparatus 500″ shown in FIGS. 17 and 18. As shown in FIGS. 17 and 18, sensor apparatus 500″ includes optical coupler 570 and integrated optics sensor array 530″″″ with a density (number of sensors) equal to the density of diffraction targets 404a-404i (number of targets) on patterned substrate 400′ rather than sensor array 530 of sensor apparatus 500 and patterned substrate 400 shown in FIGS. 5 and 6.

As shown in FIGS. 17 and 18, sensor apparatus 500″ can include integrated optics sensor array 530″″″ and optical coupler 570. Integrated optics sensor array 530″″″ can be configured to simultaneously illuminate all diffraction targets 404a-404i on patterned substrate 400′ and detect corresponding signal beams 546a-546i including diffraction order sub-beams (e.g., similar to first, second, and third diffraction order sub-beams 292, 294, 296 shown in FIGS. 2A and 2B) reflected from the diffraction targets 404a-404i. In some aspects, as shown in FIGS. 17 and 18, the number of sensors 540a-540i of integrated optics sensor array 530″″″ can equal the number of diffraction targets 404a-404i of patterned substrate 400′ (e.g., nine). In some aspects, integrated optics sensor array 500″″″ can be monolithic (e.g., single wafer). In some aspects, integrated optics sensor array 530″″″ can include optical coupler 570. For example, integrated optics sensor array 530″″″ and waveguides 572a-572i of optical coupler 570 can be formed on the same monolithic substrate (e.g., single wafer).

Optical coupler 570 can be configured to form an optical routing network between sensors 540a-540i located at predetermined positions and optical ports 514a-514i (fixed) of metrology stage 510 via waveguides 572a-572i. Optical coupler 570 can be further configured to be exchangeable (swappable) for different patterned substrates 400′. In some aspects, optical coupler 570 can be monolithic (e.g., single wafer). In some aspects, as shown in FIG. 17, optical coupler 570 can be disposed between integrated optics sensor array 500″″″ and metrology stage 510. As shown in FIGS. 17 and 18, optical coupler 570 can include waveguides 572a-572i corresponding to sensors 540a-540i. In some aspects, as shown in FIGS. 17 and 18, the number of waveguides 572a-572i of optical coupler 570 can equal the number of sensors 540a-540i (e.g., nine).

Waveguides 572a-572i can be configured to transmit signal beams 546a-546i from sensors 540a-540i to optical ports 514a-514i (fixed) of metrology stage 510, respectively. Waveguides 572a-572i can be further configured to optically couple each sensor 540a-540i, overlying a corresponding diffraction target 404a-404i, to each optical port 514a-514i (fixed) such that there is a 1:1 correspondence between diffraction targets 404a-404i and sensors 540a-540i, sensors 540a-540i and waveguides 572a-572i, and waveguides 572a-572i and optical ports 514a-514i (fixed), for simultaneous (parallel) measurement of all diffraction targets 404a-404i on patterned substrate 400′. For example, as shown in FIGS. 17 and 18, diffraction target 404d can be measured by sensor 540d, which is optically coupled to waveguide 572d that transmits signal beam 546d of sensor 540d to optical port 514d. In some aspects, waveguides 572a-572i can include silicon nitride, lithium niobate, or any other suitable material capable of transmitting signal beams 546a-546i. In some aspects, waveguides 572a-572i can include tapered waveguides for reduced stitching errors and misalignment losses (e.g., less than 4 mdB loss). For example, each waveguides 572a-572i can include a tapered waveguide having a waveguide width at a distal (interconnecting) end of at least about 5 μm, while a proximal (body) portion can have a tapered waveguide width of about 1 μm.

The embodiments may further be described using the following clauses:

1. An apparatus comprising:
a sensor array comprising a plurality of sensors, each sensor of the sensor array configured to:
   illuminate radiation to a diffraction target on a substrate comprising a plurality of diffraction targets; and
   detect a signal beam comprising diffraction order sub-beams reflected from the diffraction target; and
a metrology stage coupled to the sensor array and configured to move the sensor array relative to the substrate,
wherein the apparatus is configured to measure the plurality of diffraction targets at a rate based on a density of the plurality of sensors relative to the plurality of diffraction targets.

2. The apparatus of clause 1, wherein the apparatus is configured to measure the plurality of diffraction targets at a rate of at least 10 diffraction targets per second.

3. The apparatus of clause 1, wherein the apparatus is configured to decrease an overlay error based on detection of higher spatial frequency deformations of the substrate.

4. The apparatus of clause 1, wherein the density of the plurality of sensors is at least equal to a density of the plurality of diffraction targets.

5. The apparatus of clause 1, wherein a density of the plurality of diffraction targets is at least five times that of the density of the plurality of sensors.

6. The apparatus of clause 1, wherein a density of the plurality of diffraction targets is at least ten times that of the density of the plurality of sensors.

7. The apparatus of clause 1, wherein, in a first mode, the apparatus is configured to measure the plurality of diffraction targets sequentially such that the metrology stage moves a first sensor of the sensor array over a first diffraction target of the plurality of diffraction targets based on a minimum distance between the first sensor and the first diffraction target.

8. The apparatus of clause 7, wherein the apparatus is further configured to determine the minimum distance based on an optimization algorithm that considers relative distances between the plurality of sensors and the plurality of diffraction targets.

9. The apparatus of clause 1, wherein, in a second mode, the apparatus is configured to measure the plurality of diffraction targets simultaneously such that the metrology stage rotates at least first and second sensors of the sensor array over first and second diffraction targets of the plurality of diffraction targets, respectively, based on a relative rotation angle between the sensor array and the substrate.

10. The apparatus of clause 9, wherein the apparatus is further configured to determine the relative rotation angle based on an optimization algorithm that considers relative rotations between the plurality of sensors and the plurality of diffraction targets for a range of 0 degrees to 45 degrees.

11. The apparatus of clause 1, wherein, in a third mode, the apparatus is configured to measure the plurality of diffraction targets on the substrate simultaneously such that each sensor of the sensor array has a field-of-view that is overlapping with neighboring sensors.

12. The apparatus of clause 1, wherein each sensor of the sensor array comprises an integrated optic chip comprising:
an illumination source configured to provide an illumination beam;
an optic configured to direct the illumination beam toward the diffraction target; and
a detector configured to detect the signal beam.

13. The apparatus of clause 1, wherein each sensor of the sensor array comprises an integrated optical interconnect comprising:
an input waveguide configured to receive an illumination beam;
an optical switch configured to direct the illumination beam toward the diffraction target and receive the signal beam; and
an output waveguide configured to transmit the signal beam.

14. The apparatus of clause 13, further comprising a detector system comprising a detector, the detector system configured to collect the signal beam.

15. The apparatus of clause 14, further comprising a processor coupled to the sensor array, the metrology stage, and the detector system, the processor configured to measure a characteristic of the diffraction target based on the signal beam.

16. The apparatus of clause 15, wherein the characteristic of the diffraction target is an alignment position or an overlay error.

17. The apparatus of clause 1, wherein the sensor array overfills a surface area of the substrate.

18. The apparatus of clause 1, wherein the sensor array underfills a surface area of the substrate.

19. A detection system comprising:
a sensor array comprising a plurality of sensors disposed over a plurality of diffraction targets on a substrate, each sensor of the sensor array configured to:
   illuminate radiation to a diffraction target of the plurality of diffraction targets; and
   detect a signal beam comprising diffraction order sub-beams reflected from the diffraction target;
a metrology stage coupled to the sensor array and configured to move the sensor array relative to the substrate; and
an optical coupler between the sensor array and the metrology stage, the optical coupler comprising a plurality of waveguides optically coupled to the plurality of sensors and configured to transmit the signal beam from each sensor to a plurality of fixed optical ports.

20. The detection system of clause 19, wherein the detection system comprises a plurality of optical couplers each having the plurality of sensors positioned at predetermined positions.

21. A lithographic apparatus comprising:
an illumination system configured to illuminate a patterning device;
a projection system configured to project an image of the patterning device onto a substrate; and
a sensor apparatus configured to measure an overlay error of the lithographic apparatus, the sensor apparatus comprising:
   a sensor array comprising a plurality of sensors, each sensor of the sensor array configured to:
      illuminate radiation to a diffraction target on the substrate comprising a plurality of diffraction targets; and
      detect a signal beam comprising diffraction order sub-beams reflected from the diffraction target; and
   a metrology stage coupled to the sensor array and configured to move the sensor array relative to the substrate,
   wherein the sensor apparatus is configured to measure the plurality of diffraction targets at a rate based on a density of the plurality of sensors relative to the plurality of diffraction targets.

22. The lithographic apparatus of clause 21, wherein the lithographic apparatus is configured to decrease the overlay error based on detection of higher spatial frequency deformations of the substrate.

23. A method of measuring a plurality of diffraction targets on a substrate, the method comprising:
measuring, by a sensor apparatus, signal beams from a plurality of diffraction targets on the substrate, the sensor apparatus comprising:
   a sensor array comprising a plurality of sensors, each sensor of the sensor array configured to:
      illuminate radiation to a diffraction target on the substrate; and
      detect a signal beam comprising diffraction order sub-beams reflected from the diffraction target; and
   a metrology stage coupled to the sensor array and configured to move the sensor array relative to the substrate,
   wherein the sensor apparatus is configured to measure the plurality of diffraction targets at a rate based on a density of the plurality of sensors relative to the plurality of diffraction targets.

24. The method of clause 23, wherein measuring comprises sequentially measuring the plurality of diffraction targets.

25. The method of clause 24, wherein sequentially measuring comprises translating a first sensor of the sensor array over a first diffraction target of the plurality of diffraction targets based on a minimum distance between the first sensor and the first diffraction target.

26. The method of clause 23, wherein measuring comprises simultaneously measuring the plurality of diffraction targets.

27. The method of clause 26, wherein simultaneously measuring comprises rotating at least first and second sensors of the sensor array over first and second diffraction targets of the plurality of diffraction targets, respectively, based on a relative rotation angle between the sensor array and the substrate.

28. The method of clause 26, wherein simultaneously measuring comprises overlapping a field-of-view of each sensor of the sensor array with neighboring sensors.

29. The method of clause 26, wherein simultaneously measuring comprises:
disposing the plurality of sensors at predetermined positions over each of the plurality of diffraction targets; and
detecting signal beams from each of the plurality of sensors through an optical coupler, the optical coupler comprising a plurality of waveguides optically coupled to the plurality of sensors and a plurality of fixed optical ports.

30. The method of clause 29, further comprising exchanging the sensor array and the optical coupler with a second sensor array and a second optical coupler configured to measure a plurality of diffraction targets on a second substrate.

Although specific reference can be made in this text to the use of lithographic apparatus in the manufacture of ICs, it should be understood that the lithographic apparatus described herein may have other applications, such as the manufacture of integrated optical systems, guidance and detection patterns for magnetic domain memories, flat-panel displays, LCDs, thin-film magnetic heads, etc. The skilled artisan will appreciate that, in the context of such alternative applications, any use of the terms “wafer” or “die” herein may be considered as synonymous with the more general terms “substrate” or “target portion”, respectively. The substrate referred to herein may be processed, before or after exposure, in for example a track unit (a tool that typically applies a layer of resist to a substrate and develops the exposed resist), a metrology unit and/or an inspection unit. Where applicable, the disclosure herein may be applied to such and other substrate processing tools. Further, the substrate may be processed more than once, for example in order to create a multi-layer IC, so that the term substrate used herein may also refer to a substrate that already contains multiple processed layers.

Although specific reference may have been made above to the use of aspects in the context of optical lithography, it will be appreciated that aspects may be used in other applications, for example imprint lithography, and where the context allows, is not limited to optical lithography. In imprint lithography a topography in a patterning device defines the pattern created on a substrate. The topography of the patterning device may be pressed into a layer of resist supplied to the substrate whereupon the resist is cured by applying electromagnetic radiation, heat, pressure or a combination thereof. The patterning device is moved out of the resist leaving a pattern in it after the resist is cured.

It is to be understood that the phraseology or terminology herein is for the purpose of description and not of limitation, such that the terminology or phraseology of the present specification is to be interpreted by those skilled in relevant art(s) in light of the teachings herein.

The term “substrate” as used herein describes a material onto which material layers are added. In some aspects, the substrate itself may be patterned and materials added on top of it may also be patterned, or may remain without patterning.

The following examples are illustrative, but not limiting, of the aspects of this disclosure. Other suitable modifications and adaptations of the variety of conditions and parameters normally encountered in the field, and which would be apparent to those skilled in the relevant art(s), are within the spirit and scope of the disclosure.

Although specific reference may be made in this text to the use of the apparatus and/or system in the manufacture of ICs, it should be explicitly understood that such an apparatus and/or system has many other possible applications. For example, it can be employed in the manufacture of integrated optical systems, guidance and detection patterns for magnetic domain memories, LCD panels, thin-film magnetic heads, etc. The skilled artisan will appreciate that, in the context of such alternative applications, any use of the terms “reticle,” “wafer,” or “die” in this text should be considered as being replaced by the more general terms “mask,” “substrate,” and “target portion,” respectively.

While specific aspects have been described above, it will be appreciated that the aspects may be practiced otherwise than as described. The description is not intended to limit the scope of the claims.

It is to be appreciated that the Detailed Description section, and not the Summary and Abstract sections, is intended to be used to interpret the claims. The Summary and Abstract sections may set forth one or more but not all exemplary aspects as contemplated by the inventor(s), and thus, are not intended to limit the aspects and the appended claims in any way.

The aspects have been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific aspects will so fully reveal the general nature of the aspects that others can, by applying knowledge within the skill of the art, readily modify and/or adapt for various applications such specific aspects, without undue experimentation, without departing from the general concept of the aspects. Therefore, such adaptations and modifications are intended to be within the meaning and range of equivalents of the disclosed aspects, based on the teaching and guidance presented herein.

The breadth and scope of the aspects should not be limited by any of the above-described exemplary aspects, but should be defined only in accordance with the following claims and their equivalents.

1. An apparatus comprising:
a sensor array comprising a plurality of sensors, each sensor of the sensor array configured to:
illuminate radiation to a diffraction target on a substrate comprising a plurality of diffraction targets; and
detect a signal beam comprising diffraction order sub-beams diffracted from the diffraction target; and
a metrology stage coupled to the sensor array and configured to move the sensor array relative to the substrate,
wherein the apparatus is configured to measure the plurality of diffraction targets at a rate based on a density of the plurality of sensors relative to the plurality of diffraction targets.

2. The apparatus of claim 1, wherein the apparatus is configured to measure the plurality of diffraction targets at a rate of at least 10 diffraction targets per second.

3. The apparatus of claim 1, wherein the apparatus is configured to decrease an overlay error based on detection of higher spatial frequency deformations of the substrate.

4. The apparatus of claim 1, wherein the density of the plurality of sensors is at least equal to a density of the plurality of diffraction targets.

5. The apparatus of claim 1, wherein a density of the plurality of diffraction targets is at least five times that of the density of the plurality of sensors.

6. The apparatus of claim 1, wherein a density of the plurality of diffraction targets is at least ten times that of the density of the plurality of sensors.

7. The apparatus of claim 1, wherein, in a first mode, the apparatus is configured to measure the plurality of diffraction targets sequentially such that the metrology stage moves a first sensor of the sensor array over a first diffraction target of the plurality of diffraction targets based on a minimum distance between the first sensor and the first diffraction target.

8. The apparatus of claim 7, wherein the apparatus is further configured to determine the minimum distance based on an optimization algorithm that considers relative distances between the plurality of sensors and the plurality of diffraction targets.

9. The apparatus of claim 1, wherein, in a second mode, the apparatus is configured to measure the plurality of diffraction targets simultaneously such that the metrology stage rotates at least first and second sensors of the sensor array over first and second diffraction targets of the plurality of diffraction targets, respectively, based on a relative rotation angle between the sensor array and the substrate.

10. The apparatus of claim 9, wherein the apparatus is further configured to determine the relative rotation angle based on an optimization algorithm that considers relative rotations between the plurality of sensors and the plurality of diffraction targets for a range of 0 degrees to 45 degrees.

11. The apparatus of claim 1, wherein, in a third mode, the apparatus is configured to measure the plurality of diffraction targets on the substrate simultaneously such that each sensor of the sensor array has a field-of-view that is overlapping with neighboring sensors.

12. The apparatus of claim 1, wherein each sensor of the sensor array comprises an integrated optic chip comprising:
an illumination source configured to provide an illumination beam;
an optic configured to direct the illumination beam toward the diffraction target; and
a detector configured to detect the signal beam.

13. The apparatus of claim 1, wherein each sensor of the sensor array comprises an integrated optical interconnect comprising:
an input waveguide configured to receive an illumination beam;
an optical switch configured to direct the illumination beam toward the diffraction target and receive the signal beam; and
an output waveguide configured to transmit the signal beam.

14. The apparatus of claim 13, further comprising a detector system comprising a detector, the detector system configured to collect the signal beam.

15. The apparatus of claim 14, further comprising a processor coupled to the sensor array, the metrology stage, and the detector system, the processor configured to measure a characteristic of the diffraction target based on the signal beam.

16. A detection system comprising:
a sensor array comprising a plurality of sensors disposed over a plurality of diffraction targets on a substrate, each sensor of the sensor array configured to:
illuminate radiation to a diffraction target of the plurality of diffraction targets; and
detect a signal beam comprising diffraction order sub-beams diffracted from the diffraction target;
a metrology stage coupled to the sensor array and configured to move the sensor array relative to the substrate; and
an optical coupler between the sensor array and the metrology stage, the optical coupler comprising a plurality of waveguides optically coupled to the plurality of sensors and configured to transmit the signal beam from each sensor to a plurality of fixed optical ports.

17. The detection system of claim 16, wherein the detection system comprises a plurality of optical couplers each having the plurality of sensors positioned at predetermined positions.

18. A method of measuring a plurality of diffraction targets on a substrate using a sensor apparatus comprising:
a sensor array comprising a plurality of sensors, each sensor of the sensor array configured to:
illuminate radiation to a diffraction target on the substrate; and
detect a signal beam comprising diffraction order sub-beams diffracted from the diffraction target; and
a metrology stage coupled to the sensor array and configured to move the sensor array relative to the substrate,
the method comprising:
measuring, by the sensor apparatus, signal beams from a plurality of diffraction targets on the substrate at a rate based on a density of the plurality of sensors relative to the plurality of diffraction targets.

19. The method of claim 18, wherein the measuring comprises sequentially measuring the plurality of diffraction targets and the sequentially measuring comprises translating a first sensor of the sensor array over a first diffraction target of the plurality of diffraction targets based on a minimum distance between the first sensor and the first diffraction target.

20. The method of claim 18, wherein the measuring comprises simultaneously measuring the plurality of diffraction targets and the simultaneously measuring comprises rotating at least first and second sensors of the sensor array over first and second diffraction targets of the plurality of diffraction targets, respectively, based on a relative rotation angle between the sensor array and the substrate.
